(19) United States
(12) Patent Application Publication
(10) Pub. No.: US 2025/0212236 A1
(43) Pub. Date: Jun. 26, 2025

(54) CHANNEL SOUNDING TECHNIQUES FOR REDUCED BASEBAND BANDWIDTH DEVICES

(71) Applicant: QUALCOMM INCORPORATED, San Diego, CA (US)

(72) Inventors: Jing Dai, Beijing (CN); Chao Wei, Beijing (CN); Min Huang, Beijing (CN)

(21) Appl. No.: 18/846,625

(22) PCT Filed: May 27, 2022
(86) PCT No.: PCT/CN2022/095432

§ 371 Date: Sep. 12, 2024

(51) Int. Cl. H04W 72/512; H04L 5/00

(52) U.S. Cl. CPC H04W 72/512; H04L 5/0048

(57) ABSTRACT

Methods, systems, and devices for wireless communications are described. In some cases, a user equipment (UE) may generate a baseband payload including a set of reference signals arranged in accordance with a comb pattern. The UE may upconvert the baseband payload by repeating the payload until a radio frequency bandwidth is filled with the repetitions, and the UE may transmit the repetitions of the baseband payload over the radio frequency bandwidth. In some other cases, a UE may receive, over a radio frequency bandwidth, a signal that includes a set of reference signals arranged in accordance with a comb pattern, and the UE may downconvert the signal to a baseband payload, where the baseband payload includes, as a result of the downconverting, a subset of reference signals of the set of reference signals. The UE may obtain channel measurements for the radio frequency bandwidth using the subset of reference signals.

### CROSS REFERENCE

The present Application is a 371 national stage filing of International PCT Application No. PCT/CN2022/095432 by Dai et al. entitled “CHANNEL SOUNDING TECHNIQUES FOR REDUCED BASEBAND BANDWIDTH DEVICES,” filed May 27, 2022, which is assigned to the assignee hereof, and which is expressly incorporated by reference in its entirety herein.

### FIELD OF TECHNOLOGY

The following relates to wireless communications, including channel sounding techniques for reduced baseband bandwidth devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may communicate with or more other network devices, such as a network entity. In some cases, the network entity and the UE may have different bandwidth capabilities. Techniques for enabling communications between the UE and network entity when the devices have different bandwidth capabilities may be improved

### SUMMARY

The described techniques relate to improved methods, systems, devices, and apparatuses that support channel sounding techniques for reduced baseband bandwidth devices. For example, the described techniques provide for improved methods to enable a user equipment (UE) to perform channel sounding beyond the UEs baseband bandwidth capability. For example, a UE may support a baseband bandwidth capability that this less than a radio frequency bandwidth capability of a network entity (e.g., a system BW). To support dynamic bandwidth part (BWP) switching at the UE, the UE may be configured to support transmitting reference signals and/or receiving reference signals beyond the baseband bandwidth capability of the UE.

In an example of the UE transmitting reference signals, the UE may generate a baseband payload including a set of one or more reference signals arranged in accordance with a comb pattern, where the baseband payload is associated with a baseband bandwidth of the UE. The UE may upconvert the baseband payload by repeating the baseband payload until a radio frequency bandwidth larger than the baseband bandwidth is filled with repetitions of the baseband payload, and the UE may transmit the repetitions of the baseband payload over the radio frequency bandwidth. Each of the repetitions of the baseband payload may include the set of one or more reference signals arranged in accordance with the comb pattern. A network entity may receive, over a radio frequency bandwidth, the signal including a set of reference signals arranged across the radio frequency bandwidth in accordance with a comb pattern and the network entity may obtain channel measurements for the radio frequency bandwidth using the set of reference signals.

In an example of the UE receiving reference signals, a network entity may generate, over a radio frequency bandwidth, a signal including a set of reference signals arranged in accordance with a comb pattern based on a baseband bandwidth capability of a UE, and the network entity may transmit, over the radio frequency bandwidth, the signal including the set of reference signals arranged across the radio frequency bandwidth in accordance with the comb pattern. Accordingly, the UE may receive, over a radio frequency bandwidth, a signal that includes a set of reference signals arranged across the radio frequency bandwidth in accordance with a comb pattern. The UE may downconvert the signal from the radio frequency bandwidth to a baseband payload associated with a baseband bandwidth of the UE, where the baseband bandwidth is smaller than the radio frequency bandwidth, and the baseband payload may include, as a result of the downconverting, a subset of reference signals of the set of reference signals. The subset of reference signals may be representative of the radio frequency bandwidth. The UE may obtain channel measurements for the radio frequency bandwidth using the subset of reference signals included in the baseband payload based on the subset of reference signals being representative of the radio frequency bandwidth.

A method for wireless communications at a UE is described. The method may include generating a baseband payload including a set of one or more reference signals arranged in accordance with a comb pattern, where the baseband payload is associated with a baseband bandwidth of the UE, upconverting the baseband payload by repeating the baseband payload until a radio frequency bandwidth larger than the baseband bandwidth is filled with repetitions of the baseband payload, and transmitting the repetitions of the baseband payload over the radio frequency bandwidth, each of the repetitions of the baseband payload including the set of one or more reference signals arranged in accordance with the comb pattern.

An apparatus for wireless communications is described. The apparatus may include a processor, memory coupled with the processor, and instructions stored in the memory. The instructions may be executable by the processor to cause the apparatus to generate a baseband payload including a set of one or more reference signals arranged in accordance with a comb pattern, where the baseband payload is associated with a baseband bandwidth of the UE, upconvert the baseband payload by repeating the baseband payload until a radio frequency bandwidth larger than the baseband bandwidth is filled with repetitions of the baseband payload, and transmit the repetitions of the baseband payload over the radio frequency bandwidth, each of the repetitions of the baseband payload including the set of one or more reference signals arranged in accordance with the comb pattern.

Another apparatus for wireless communications is described. The apparatus may include means for generating a baseband payload including a set of one or more reference signals arranged in accordance with a comb pattern, where the baseband payload is associated with a baseband bandwidth of the UE, means for upconverting the baseband payload by repeating the baseband payload until a radio frequency bandwidth larger than the baseband bandwidth is filled with repetitions of the baseband payload, and means for transmitting the repetitions of the baseband payload over the radio frequency bandwidth, each of the repetitions of the baseband payload including the set of one or more reference signals arranged in accordance with the comb pattern.

A non-transitory computer-readable medium storing code for wireless communications is described. The code may include instructions executable by a processor to generate a baseband payload including a set of one or more reference signals arranged in accordance with a comb pattern, where the baseband payload is associated with a baseband bandwidth of the UE, upconvert the baseband payload by repeating the baseband payload until a radio frequency bandwidth larger than the baseband bandwidth is filled with repetitions of the baseband payload, and transmit the repetitions of the baseband payload over the radio frequency bandwidth, each of the repetitions of the baseband payload including the set of one or more reference signals arranged in accordance with the comb pattern.

Some examples of the method, apparatuses, and non-transitory computer-readable medium described herein may further include operations, features, means, or instructions for transmitting a capability message indicative that the UE supports the baseband bandwidth that may be less than the radio frequency bandwidth, where generating the baseband payload and upconverting the baseband payload may be based on the capability message.

Some examples of the method, apparatuses, and non-transitory computer-readable medium described herein may further include operations, features, means, or instructions for transmitting a capability message indicative that the UE may be capable of upconverting the baseband payload by repeating the baseband payload until the radio frequency bandwidth may be filled with repetitions of the baseband payload.

Some examples of the method, apparatuses, and non-transitory computer-readable medium described herein may further include operations, features, means, or instructions for receiving a message including an indication of the comb pattern for the UE to apply to the set of one or more reference signals.

Some examples of the method, apparatuses, and non-transitory computer-readable medium described herein may further include operations, features, means, or instructions for receiving a message indicating for the UE to generate the baseband payload and upconvert the baseband payload by repeating the baseband payload until the radio frequency bandwidth may be filled with the repetitions of the baseband payload.

In some examples of the method, apparatuses, and non-transitory computer-readable medium described herein, generating the baseband payload may include operations, features, means, or instructions for arranging the set of one or more reference signals in accordance with the comb pattern based on a number of repetitions of the baseband payload to fill the radio frequency bandwidth, where a comb value associated with the comb pattern may be greater than or equal to the number of repetitions.

In some examples of the method, apparatuses, and non-transitory computer-readable medium described herein, switching, during a transmission gap prior to a reference signal of the set of one or more reference signals, from transmitting over a narrowband bandwidth equal to the baseband bandwidth to transmitting over the radio frequency bandwidth to transmit the reference signal from the set of one or more reference signals.

In some examples of the method, apparatuses, and non-transitory computer-readable medium described herein, switching, during a transmission gap after a reference signal of the set of one or more reference signals, from transmitting over the radio frequency bandwidth to transmitting over a narrowband bandwidth equal to the baseband bandwidth to transmit signals other than the set of one or more reference signals.

In some examples of the method, apparatuses, and non-transitory computer-readable medium described herein, a transmission gap for switching between transmitting over a narrowband bandwidth equal to the baseband bandwidth or the radio frequency bandwidth may be based on whether a center frequency of the baseband bandwidth may be equivalent to a center frequency of the radio frequency bandwidth.

In some examples of the method, apparatuses, and non-transitory computer-readable medium described herein, a center frequency of a narrowband bandwidth equal to the baseband bandwidth may be equivalent to a center frequency of the radio frequency bandwidth.

In some examples of the method, apparatuses, and non-transitory computer-readable medium described herein, a center frequency of a narrowband bandwidth equal to the baseband bandwidth may be different from a center frequency of the radio frequency bandwidth.

A method for wireless communications at a network entity is described. The method may include receiving, over a radio frequency bandwidth, a signal including a set of reference signals arranged across the radio frequency bandwidth in accordance with a comb pattern based on a baseband bandwidth supported by a UE and obtaining channel measurements for the radio frequency bandwidth using the set of reference signals.

An apparatus for wireless communications is described. The apparatus may include a processor, memory coupled with the processor, and instructions stored in the memory. The instructions may be executable by the processor to cause the apparatus to receive, over a radio frequency bandwidth, a signal including a set of reference signals arranged across the radio frequency bandwidth in accordance with a comb pattern based on a baseband bandwidth supported by a UE and obtain channel measurements for the radio frequency bandwidth using the set of reference signals.

Another apparatus for wireless communications is described. The apparatus may include means for receiving, over a radio frequency bandwidth, a signal including a set of reference signals arranged across the radio frequency bandwidth in accordance with a comb pattern based on a baseband bandwidth supported by a UE and means for obtaining channel measurements for the radio frequency bandwidth using the set of reference signals.

A non-transitory computer-readable medium storing code for wireless communications is described. The code may include instructions executable by a processor to receive, over a radio frequency bandwidth, a signal including a set of reference signals arranged across the radio frequency bandwidth in accordance with a comb pattern based on a baseband bandwidth supported by a UE and obtain channel measurements for the radio frequency bandwidth using the set of reference signals.

Some examples of the method, apparatuses, and non-transitory computer-readable medium described herein may further include operations, features, means, or instructions for receiving a capability message indicative that the UE supports the baseband bandwidth that may be less than the radio frequency bandwidth, where receiving the signal may be based on the capability message.

Some examples of the method, apparatuses, and non-transitory computer-readable medium described herein may further include operations, features, means, or instructions for receiving a capability message indicative that the UE may be capable of upconverting a baseband payload by repeating the baseband payload until the radio frequency bandwidth may be filled with repetitions of the baseband payload.

Some examples of the method, apparatuses, and non-transitory computer-readable medium described herein may further include operations, features, means, or instructions for transmitting a message including an indication of the comb pattern for the UE to apply to the signal.

Some examples of the method, apparatuses, and non-transitory computer-readable medium described herein may further include operations, features, means, or instructions for transmitting a message indicating for the UE to generate a baseband payload and upconvert the baseband payload by repeating the baseband payload until the radio frequency bandwidth may be filled with repetitions of the baseband payload.

In some examples of the method, apparatuses, and non-transitory computer-readable medium described herein, the set of reference signals may be arranged in accordance with the comb pattern based on a number of repetitions of a baseband payload of the UE to fill the radio frequency bandwidth, a comb value associated with the comb pattern may be greater than or equal to the number of repetitions.

In some examples of the method, apparatuses, and non-transitory computer-readable medium described herein, a number of subcarriers between each reference signal of the set of reference signals may be unoccupied based on an integer multiple of the baseband bandwidth of the UE to the radio frequency bandwidth, the number of subcarriers left unoccupied may be equal to the integer multiple minus one.

A method for wireless communications at a UE is described. The method may include receiving, over a radio frequency bandwidth, a signal that includes a set of reference signals arranged across the radio frequency bandwidth in accordance with a comb pattern, downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth, and obtaining channel measurements for the radio frequency bandwidth using the subset of reference signals included in the baseband payload based on the subset of reference signals being representative of the radio frequency bandwidth.

An apparatus for wireless communications is described. The apparatus may include a processor, memory coupled with the processor, and instructions stored in the memory. The instructions may be executable by the processor to cause the apparatus to receive, over a radio frequency bandwidth, a signal that includes a set of reference signals arranged across the radio frequency bandwidth in accordance with a comb pattern, downconvert the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth, and obtain channel measurements for the radio frequency bandwidth using the subset of reference signals included in the baseband payload based on the subset of reference signals being representative of the radio frequency bandwidth.

Another apparatus for wireless communications is described. The apparatus may include means for receiving, over a radio frequency bandwidth, a signal that includes a set of reference signals arranged across the radio frequency bandwidth in accordance with a comb pattern, means for downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth, and means for obtaining channel measurements for the radio frequency bandwidth using the subset of reference signals included in the baseband payload based on the subset of reference signals being representative of the radio frequency bandwidth.

A non-transitory computer-readable medium storing code for wireless communications is described. The code may include instructions executable by a processor to receive, over a radio frequency bandwidth, a signal that includes a set of reference signals arranged across the radio frequency bandwidth in accordance with a comb pattern, downconvert the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth, and obtain channel measurements for the radio frequency bandwidth using the subset of reference signals included in the baseband payload based on the subset of reference signals being representative of the radio frequency bandwidth.

Some examples of the method, apparatuses, and non-transitory computer-readable medium described herein may further include operations, features, means, or instructions for transmitting a capability message indicative that the UE supports the baseband bandwidth that may be less than the radio frequency bandwidth, where the signal may be based on the capability message.

Some examples of the method, apparatuses, and non-transitory computer-readable medium described herein may further include operations, features, means, or instructions for transmitting a capability message indicative that the UE may be capable of downconverting the signal from the radio frequency bandwidth to the baseband payload associated with the baseband bandwidth of the UE, where receiving the signal may be based on the capability message.

Some examples of the method, apparatuses, and non-transitory computer-readable medium described herein may further include operations, features, means, or instructions for receiving a message indicating for the UE to downconvert the signal from the radio frequency bandwidth to the baseband payload associated with the baseband bandwidth of the UE.

In some examples of the method, apparatuses, and non-transitory computer-readable medium described herein, downconverting the signal may include operations, features, means, or instructions for aligning a number of analog carriers of the signal in a staggered configuration resulting in the baseband payload including the subset of reference signals representative of the radio frequency bandwidth, where the number of analog carriers may be equal to the radio frequency bandwidth divided by the baseband bandwidth.

Some examples of the method, apparatuses, and non-transitory computer-readable medium described herein may further include operations, features, means, or instructions for receiving a second signal over a narrowband bandwidth and applying a wideband filter to the signal received over the radio frequency bandwidth, the second signal received over the narrowband bandwidth, or both regardless of the respective bandwidths of the signal and the second signal.

Some examples of the method, apparatuses, and non-transitory computer-readable medium described herein may further include operations, features, means, or instructions for receiving a second signal over a narrowband bandwidth and applying a wideband filter to the signal received over the radio frequency bandwidth and a narrowband filter to the second signal received over the narrowband bandwidth based on the respective bandwidths of the signal and the second signal.

Some examples of the method, apparatuses, and non-transitory computer-readable medium described herein may further include operations, features, means, or instructions for switching, during a measurement gap prior to a reference signal of the set of reference signals, from monitoring a narrowband bandwidth equal to the baseband bandwidth to monitoring the radio frequency bandwidth to receive the reference signal.

Some examples of the method, apparatuses, and non-transitory computer-readable medium described herein may further include operations, features, means, or instructions for switching, during a measurement gap after a reference signal of the set of reference signals, from monitoring the radio frequency bandwidth to monitoring a narrowband bandwidth equal to the baseband bandwidth to receive signals other than the set of reference signals.

In some examples of the method, apparatuses, and non-transitory computer-readable medium described herein, a measurement gap for switching between monitoring the baseband bandwidth or the radio frequency bandwidth may be based on whether a center frequency of a narrowband bandwidth equal to the baseband bandwidth may be equivalent to a center frequency of the radio frequency bandwidth.

In some examples of the method, apparatuses, and non-transitory computer-readable medium described herein, a center frequency of a narrowband bandwidth equal to the baseband bandwidth may be equivalent to a center frequency of the radio frequency bandwidth.

In some examples of the method, apparatuses, and non-transitory computer-readable medium described herein, a center frequency of a narrowband bandwidth equal to the baseband bandwidth may be different from a center frequency of the radio frequency bandwidth.

In some examples of the method, apparatuses, and non-transitory computer-readable medium described herein, the set of reference signals may be arranged in accordance with the comb pattern based on a result of dividing the radio frequency bandwidth by the baseband bandwidth, a comb value associated with the comb pattern may be greater than or equal to the result.

In some examples of the method, apparatuses, and non-transitory computer-readable medium described herein, a number of subcarriers between each reference signal of the set of reference signals may be unoccupied based on an integer multiple of the baseband bandwidth to the radio frequency bandwidth, the number of subcarriers left unoccupied may be equal to the integer multiple minus one.

In some examples of the method, apparatuses, and non-transitory computer-readable medium described herein, the unoccupied subcarriers may be adjacent to one another, or may be arranged in accordance with a frequency interval based on a rate matching pattern.

A method for wireless communications at a network entity is described. The method may include generating, over a radio frequency bandwidth, a signal including a set of reference signals arranged in accordance with a comb pattern based on a baseband bandwidth capability of a UE and transmitting, over the radio frequency bandwidth, the signal including the set of reference signals arranged across the radio frequency bandwidth in accordance with the comb pattern.

An apparatus for wireless communications is described. The apparatus may include a processor, memory coupled with the processor, and instructions stored in the memory. The instructions may be executable by the processor to cause the apparatus to generate, over a radio frequency bandwidth, a signal including a set of reference signals arranged in accordance with a comb pattern based on a baseband bandwidth capability of a UE and transmit, over the radio frequency bandwidth, the signal including the set of reference signals arranged across the radio frequency bandwidth in accordance with the comb pattern.

Another apparatus for wireless communications is described. The apparatus may include means for generating, over a radio frequency bandwidth, a signal including a set of reference signals arranged in accordance with a comb pattern based on a baseband bandwidth capability of a UE and means for transmitting, over the radio frequency bandwidth, the signal including the set of reference signals arranged across the radio frequency bandwidth in accordance with the comb pattern.

A non-transitory computer-readable medium storing code for wireless communications is described. The code may include instructions executable by a processor to generate, over a radio frequency bandwidth, a signal including a set of reference signals arranged in accordance with a comb pattern based on a baseband bandwidth capability of a UE and transmit, over the radio frequency bandwidth, the signal including the set of reference signals arranged across the radio frequency bandwidth in accordance with the comb pattern.

Some examples of the method, apparatuses, and non-transitory computer-readable medium described herein may further include operations, features, means, or instructions for receiving a capability message indicative that the UE supports a baseband bandwidth that may be less than the radio frequency bandwidth, where generating the signal may be based on the capability message.

Some examples of the method, apparatuses, and non-transitory computer-readable medium described herein may further include operations, features, means, or instructions for receiving a capability message indicative that the UE may be capable of downconverting the signal from the radio frequency bandwidth to a baseband payload associated with a baseband bandwidth of the UE, where generating the signal may be based on the capability message.

Some examples of the method, apparatuses, and non-transitory computer-readable medium described herein may further include operations, features, means, or instructions for transmitting a message indicating for the UE to downconvert the signal from the radio frequency bandwidth to a baseband payload associated with a baseband bandwidth of the UE.

In some examples of the method, apparatuses, and non-transitory computer-readable medium described herein, generating the signal may include operations, features, means, or instructions for arranging a measurement gap before and after each reference signal of the set of reference signals, where the measurement gap may be based on whether a center frequency of a narrowband bandwidth equal to a baseband bandwidth of the UE may be equivalent to a center frequency of the radio frequency bandwidth.

In some examples of the method, apparatuses, and non-transitory computer-readable medium described herein, generating the signal may include operations, features, means, or instructions for arranging the set of reference signals in accordance with the comb pattern based on a number of repetitions of a baseband payload of the UE to fill the radio frequency bandwidth, where a comb value associated with the comb pattern may be greater than or equal to the number of repetitions.

In some examples of the method, apparatuses, and non-transitory computer-readable medium described herein, generating the signal may include operations, features, means, or instructions for refraining from occupying a number of subcarriers between each reference signal of the set of reference signals based on an integer multiple of a baseband bandwidth of the UE to the radio frequency bandwidth, where the number of subcarriers left unoccupied may be equal to the integer multiple minus one.

In some examples of the method, apparatuses, and non-transitory computer-readable medium described herein, the unoccupied subcarriers may be adjacent to one another, or may be arranged in accordance with a frequency interval based on a rate matching pattern.

### BRIEF DESCRIPTION OF THE DRAWINGS

FIG. 1 illustrates an example of a wireless communications system that supports channel sounding techniques for reduced baseband bandwidth devices in accordance with one or more aspects of the present disclosure.

FIG. 2 illustrates an example of a wireless communications system that supports channel sounding techniques for reduced baseband bandwidth devices in accordance with one or more aspects of the present disclosure.

FIGS. 3A and 3B illustrate examples of rate-matching patterns that support channel sounding techniques for reduced baseband bandwidth devices in accordance with one or more aspects of the present disclosure.

FIG. 4 illustrates an example of a wireless communications system that supports channel sounding techniques for reduced baseband bandwidth devices in accordance with one or more aspects of the present disclosure.

FIGS. 5A and 5B illustrate examples of frequency configurations that support channel sounding techniques for reduced baseband bandwidth devices in accordance with one or more aspects of the present disclosure.

FIGS. 6A and 6B illustrate examples of radio frequency architectures that support channel sounding techniques for reduced baseband bandwidth devices in accordance with one or more aspects of the present disclosure.

FIGS. 7 and 8 illustrate examples of process flows that support channel sounding techniques for reduced baseband bandwidth devices in accordance with one or more aspects of the present disclosure.

FIGS. 9 and 10 show block diagrams of devices that support channel sounding techniques for reduced baseband bandwidth devices in accordance with one or more aspects of the present disclosure.

FIG. 11 shows a block diagram of a communications manager that supports channel sounding techniques for reduced baseband bandwidth devices in accordance with one or more aspects of the present disclosure.

FIG. 12 shows a diagram of a system including a device that supports channel sounding techniques for reduced baseband bandwidth devices in accordance with one or more aspects of the present disclosure.

FIGS. 13 and 14 show block diagrams of devices that support channel sounding techniques for reduced baseband bandwidth devices in accordance with one or more aspects of the present disclosure.

FIG. 15 shows a block diagram of a communications manager that supports channel sounding techniques for reduced baseband bandwidth devices in accordance with one or more aspects of the present disclosure.

FIG. 16 shows a diagram of a system including a device that supports channel sounding techniques for reduced baseband bandwidth devices in accordance with one or more aspects of the present disclosure.

FIGS. 17 through 22 show flowcharts illustrating methods that support channel sounding techniques for reduced baseband bandwidth devices in accordance with one or more aspects of the present disclosure.

### DETAILED DESCRIPTION

A user equipment (UE) may be configured to support a baseband bandwidth that is smaller than a system bandwidth (BW) (e.g., a bandwidth supported by a network entity) so as to conserve power and reduce cost of the UE. However, for a UE with smaller bandwidth capability than the system bandwidth, scheduling efficiency may be decreased if the UE's data transmissions are limited within a (semi-)fixed narrow BW. Although some systems support dynamic bandwidth part (BWP) switching and cross-BWP scheduling, the UE may not be configured to monitor the other parts of the system bandwidth other than that which corresponds to the UE's baseband bandwidth. Therefore, even if the UE could participate in BWP switching, the UE may not be able to identify the channel quality of the system bandwidth outside the baseband bandwidth because the UE is not required to receive channel state information reference signals (CSI-RSs) or transmit sounding reference signals (SRSs) outside the active BWP.

The techniques described herein support channel sounding techniques to be performed by a UE and/or network entity when the UE is configured with a baseband bandwidth smaller than the system bandwidth. In downlink scenarios, a network entity may transmit reference signals (e.g., CSI-RSs) over the system bandwidth (e.g., radio frequency bandwidth) in accordance with a comb pattern. The UE may receive the reference signals over the entire system bandwidth but may then perform a down conversion procedure with shifted (e.g., staggered) carriers to capture reference signals representative of the entire system bandwidth within a baseband payload associated with a baseband bandwidth supported by the UE. The UE may then perform channel measurements using the reference signals in the baseband payload based on the subset of reference signals being representative of the entire system bandwidth. Therefore, the UE may dynamically switch BWP based on the channel measurements. In uplink scenarios, the UE may generate a baseband payload including reference signals arranged in accordance with a comb pattern. The UE may then upconvert the baseband payload from the baseband bandwidth to the system bandwidth by repeating the baseband payload until the system bandwidth is filled by repetitions of the baseband payload. The UE may transmit the repetitions of the baseband payload over the system bandwidth which a network entity may receive and process in full or perform a similar down conversion process described with reference to the downlink scenario.

Particular aspects of the subject matter described herein may be implemented to realize one or more advantages. The described techniques may support improvements in enabling channel sounding procedures when a baseband bandwidth capability of a UE is less than a bandwidth capability of the system. The described techniques may support improved reliability, decreased latency, and reduced power consumption, among other advantages. As such, supported techniques may include improved network operations and, in some examples, may promote network efficiencies, among other benefits.

Aspects of the disclosure are initially described in the context of wireless communications systems. Aspects are further described with reference to rate-matching patterns, frequency configurations, radio frequency architectures, and process flows. Aspects of the disclosure are further illustrated by and described with reference to apparatus diagrams, system diagrams, and flowcharts that relate to channel sounding techniques for reduced baseband bandwidth devices.

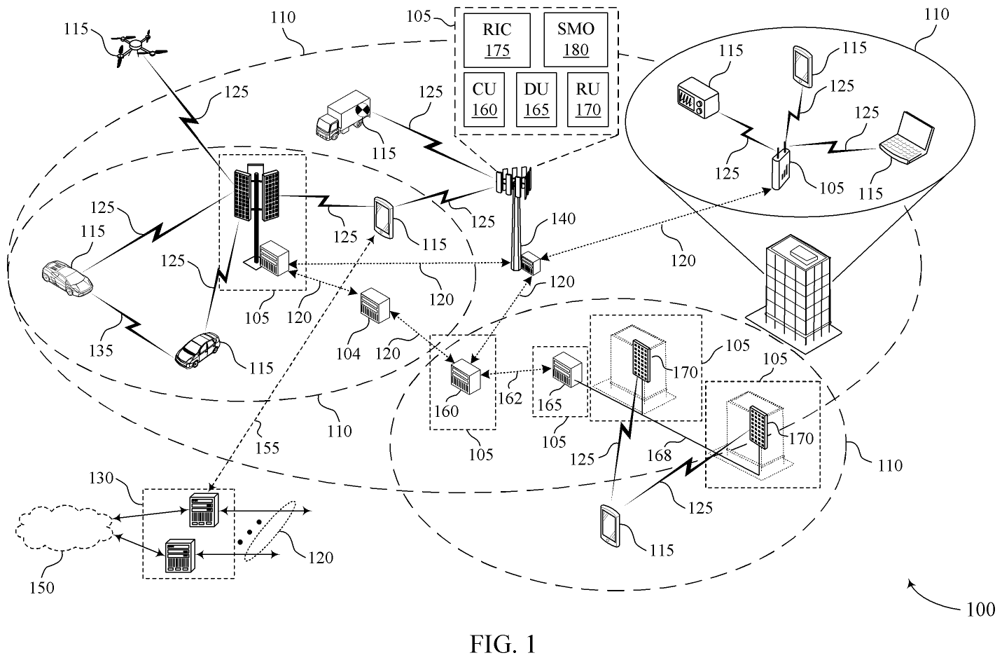

FIG. 1 illustrates an example of a wireless communications system 100 that supports channel sounding techniques for reduced baseband bandwidth devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, radio frequency functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support channel sounding techniques for reduced baseband bandwidth devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an radio frequency spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The techniques described herein provide for improved methods to enable a UE 115 to perform channel sounding beyond the UEs baseband bandwidth capability. For example, a UE 115 may support a baseband bandwidth capability that this less than a radio frequency bandwidth capability of a network entity 105 (e.g., bandwidth capability of the wireless communications system 100). To support dynamic BWP switching at the UE 115, the UE 115 may be configured to support transmitting reference signals and/or receiving reference signals beyond the baseband bandwidth capability of the UE 115.

In an example of the UE 115 transmitting reference signals, the UE 115 may generate a baseband payload including a set of one or more reference signals arranged in accordance with a comb pattern, where the baseband payload is associated with a baseband bandwidth of the UE 115. The UE 115 may upconvert the baseband payload by repeating the baseband payload until a radio frequency bandwidth larger than the baseband bandwidth is filled with repetitions of the baseband payload, and the UE 115 may transmit the repetitions of the baseband payload over the radio frequency bandwidth. Each of the repetitions of the baseband payload may include the set of one or more reference signals arranged in accordance with the comb pattern. A network entity 105 may receive, over a radio frequency bandwidth, the signal including the set of reference signals arranged across the radio frequency bandwidth in accordance with a comb pattern and the network entity 105 may obtain channel measurements for the radio frequency bandwidth using the set of reference signals.

In an example of the UE 115 receiving reference signals, a network entity 105 may generate, over a radio frequency bandwidth, a signal including a set of reference signals arranged in accordance with a comb pattern based on a baseband bandwidth capability of a UE 115, and the network entity 105 may transmit, over the radio frequency bandwidth, the signal including the set of reference signals arranged across the radio frequency bandwidth in accordance with the comb pattern. Accordingly, the UE 115 may receive, over a radio frequency bandwidth, a signal that includes a set of reference signals arranged across the radio frequency bandwidth in accordance with a comb pattern. The UE 115 may downconvert the signal from the radio frequency bandwidth to a baseband payload associated with a baseband bandwidth of the UE 115, where the baseband bandwidth is smaller than the radio frequency bandwidth, and the baseband payload may include, as a result of the downconverting, a subset of reference signals of the set of reference signals. The subset of reference signals may be representative of the radio frequency bandwidth. The UE 115 may obtain channel measurements for the radio frequency bandwidth using the subset of reference signals included in the baseband payload based on the subset of reference signals being representative of the radio frequency bandwidth.

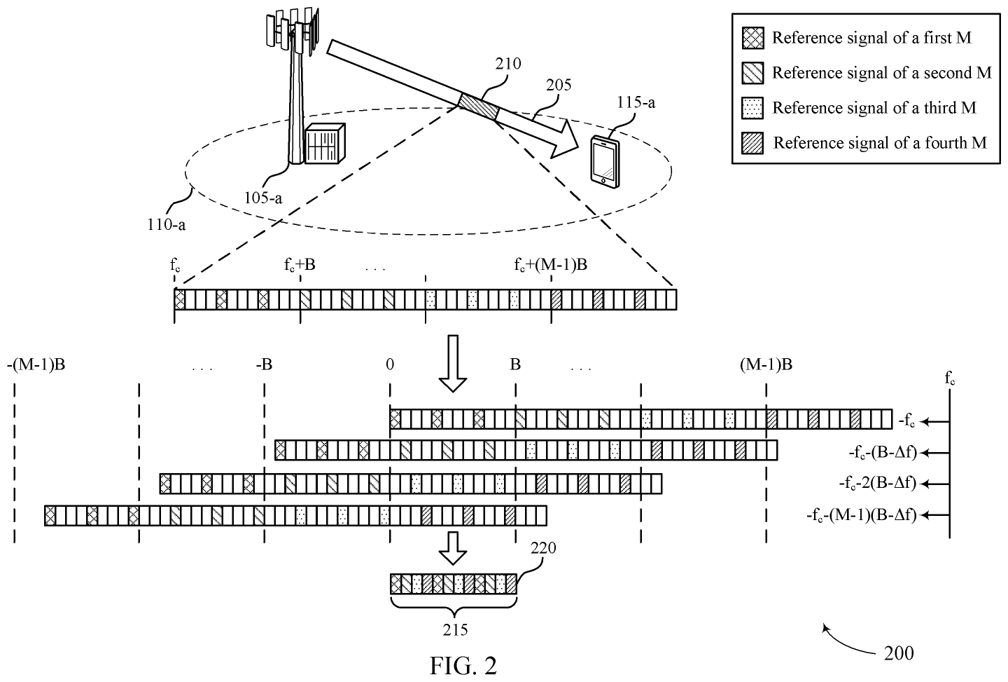

FIG. 2 illustrates an example of a wireless communications system 200 that supports channel sounding techniques for reduced baseband bandwidth devices in accordance with one or more aspects of the present disclosure. The wireless communications system 200 may include network entity 105-a and UE 115-a, which may be examples of a network entity 105 and a UE 115 as described with reference to FIG. 1. Network entity 105-a may serve a geographic coverage area 110-a. In some cases, UE 115-a may implement a down conversion procedure to perform channel sounding with a baseband payload representative of a radio frequency bandwidth. Additionally, or alternatively, other wireless devices, such as a network node, a network entity 105, etc., may implement a same or similar down conversion procedure.

In some wireless communications systems, such as wireless communications system 200, a UE 115 may be configured to support a baseband bandwidth that is smaller than a system bandwidth (e.g., a bandwidth supported by a network entity 105-a) so as to conserve power and reduce cost of UE 115-a. However, for a UE 115 with smaller bandwidth capability than the system bandwidth, scheduling efficiency may be decreased if the UE's data transmissions are limited within a (semi-)fixed narrow BW. Although some systems support dynamic BWP switching and cross-BWP scheduling, the UE 115 may not be configured to monitor the other parts of the system bandwidth other than that which corresponds to the UE's baseband bandwidth. Therefore, even if the UE 115 could participate in BWP switching, the UE 115 may not be able to identify the channel quality of the system bandwidth outside the baseband bandwidth because the UE 115 is not required to receive channel state information reference signals (CSI-RSs) or transmit sounding reference signals (SRSs) outside the active BWP.

Accordingly, UE 115-a may be configured to support channel sounding techniques to be performed by UE 115-a and/or network entity 105-a when UE 115-a is configured with a baseband bandwidth smaller than the system bandwidth. In downlink scenarios, such as that depicted in FIG. 2, a network entity 105-a may transmit a signal 210 (e.g., via communication link 205) including one or more reference signals 220 (e.g., CSI-RSs) over the system bandwidth (e.g., a radio frequency bandwidth, a bandwidth support by network entity 105-a, a transmission bandwidth and/or receiving bandwidth support by UE 115-a). However, because the system bandwidth is larger than the baseband bandwidth supported by UE 115-b, the UE 115-a may be configured to downconvert the references signals 220 received across the system bandwidth to a baseband payload 215 associated with the baseband bandwidth supported by UE 115-a such that the baseband payload 215 includes a set of reference signals representative of the system BW.

For the down conversion to result in a baseband payload 215 that includes reference signals from across the system BW, the network entity 105-a may arrange the reference signals 220 in accordance with a comb pattern (e.g., a comb value (C)) and network entity 105-a may transmit combed reference signals 220 across the system bandwidth as integer multiples (M) of the baseband bandwidth (B), where the baseband bandwidth may be equal to an integer multiplied by the subcarrier spacing (SCS) (e.g., B=KΔf, where Δf is representative of the SCS). For example, the baseband bandwidth may fit into the system bandwidth M times. Accordingly, the radio frequency bandwidth is equal to the integer multiple multiplied by the baseband bandwidth (e.g., M*B). For example, network entity 105-a may transmit a signal 210 that includes reference signals 220 arranged in accordance with a comb pattern, where the signal can be divided into multiples (M) of the baseband bandwidth (B) starting at a first frequency (f_{c}). The integer multiples may start at fc and then one baseband bandwidth from fc may result in fc+B, and so on until fc+(M−1)B is reached to account for the system bandwidth. As depicted in FIG. 2, the system bandwidth is divided into integer multiples of the baseband BW, where each multiple includes a set of reference signals pattern coded for that multiple (e.g., the first M, the second M, the third M, the fourth M).

UE 115-a may receive the reference signals 220 over the entire system bandwidth but may then perform a down conversion procedure with shifted (e.g., staggered) carriers (e.g., analog carriers) to capture reference signals 220 representative of the entire system bandwidth within a baseband payload 215 associated with a baseband bandwidth supported by UE 115-a. For receiving with staggered down-conversion with a group of analog carriers at UE 115-a, the carrier frequencies {f_{c}+m(B−X·Δf), m=0,1, . . . , M−1} are shifted by mXΔf with respect to the M BWs {f_{c}+mB, m=0,1, . . . , M−1}, respectively. Accordingly, UE 115-a may downconvert the reference signals 220 to baseband payload 215 by a group of M analog carriers. For example, the analog carriers may be represented by −fc, −fc−(B−Δf), −fc−2(B−Δf), . . . , and −fc−(M−1)(B−Δf). In accordance with the −-fc carrier, the start (e.g., fc) of the received signal 210 may be located at zero. Then, in accordance with the −fc−(B−Δf) carrier, the start of the received signal 210 may be shifted −(B−Δf) from zero. Similarly, in accordance with the −fc−2(B−Δf) carrier, the start of the received signal 210 may be shifted −2(B−Δf) from zero, and so on until the start of the signal is shifted −(M−1)(B−Δf) from zero. As depicted in FIG. 2, M may be equal to four. In some cases, the M sections of the signal 410 may include different reference signals, arranged with different comb patterns, etc. from one another. UE 115-a may then align the analog carriers in the staggered configuration resulting in the baseband payload 215 including the subset of reference signals representative of the radio frequency bandwidth.

With properly staggered down-conversion, all non-zero resource elements of the reference signals can be received within the baseband BW, represented in FIG. 2 by baseband payload 215. For example, the baseband payload includes pattern coded reference signals from each multiple that the system bandwidth was divided into such that the baseband payload includes reference signals from across and representative of the system bandwidth. Network entity 105-a may determine the comb value based on the integer multiple, M, to allow for enough resource elements (e.g., subcarriers) between reference signals 220 that during the down conversion procedure, a reference signal 220 from each multiple of the signal 210 (e.g., depicted by the different patterned reference signals 220) can fit between two reference signals 220 of the first multiple of the signal 210 (e.g., the multiple between f_{c} and f_{c}+B). For example, the comb value (e.g., frequency interval) of the reference signals may be configured to satisfy C≥M. In some cases, for the unused C−1 subcarriers between two used combs for reference signals, M−1 of them may be left unoccupied by other transmissions (e.g., non-reference reference signal transmissions). For example, network entity 105-a may refrain from occupying a number of subcarriers between each reference signal based on the integer multiple, where the number of subcarriers left unoccupied may be equal to the integer multiple minus one. Again, network entity 105-a refrain from occupying the number of subcarriers to allow for enough empty subcarriers between reference signals that during the down conversion procedure, a reference signal from each multiple of the signal 210 can fit between two reference signals of the first multiple.

UE 115-a may then perform channel measurements (e.g., channel sounding) using the reference signals 220 in the baseband payload 215 based on the subset of reference signals being representative of the entire system bandwidth. Therefore, UE 115-a may dynamically switch BWPs based on the channel measurements because UE 115-a is knowledgeable of the system bandwidth. Additionally, or alternatively, UE 115-a may indicate results of the channel sounding to network entity 105-a and network entity 105-a may configure UE 115-a to switch BWPs.

In some implementations, prior to performing down conversion, UE 115-a may determine and/or be configured to transmit one or more capability messages to network entity 105-a. UE 115-a may indicate, via the one or more capability messages, the baseband bandwidth capability of UE 115-a such as the baseband bandwidth support by UE 115-a, or whether the supported baseband bandwidth is less than the system BW, or a combination thereof. In some cases, UE 115-a may indicate, via the one or more capability messages, whether the UE 115-a supports down conversion of a signal to a baseband payload. UE 115-a may transmit the one or more capability messages upon connecting with network entity 105-a, such as via RRC signaling, or some other control signaling. In some cases, UE 115-a may transmit the capability upon request by network entity 105-a or UE 115-a may autonomously determine to transmit the one or more capability messages, via RRC, MAC-CE, UCI, etc.

In some implementations, network entity 105-a may transmit (e.g., via an RRC message, MAC-CE message, DCI message) a configuration message to UE 115-a. In some cases, the configuration message may indicate that UE 115-a is to downconvert the signal to the baseband payload. In some cases, the configuration message may indicate the multiple M, the comb value, the system BW, etc. In some cases, UE 115-a may determine the multiple M (e.g., and thus the number of analog carriers), the comb value, the system BW, etc. based on the configuration message, and/or based on a calculation by UE 115-a. In some cases, the configuration message may indicate that UE 115-a is to receive the one or more reference signals 210. The configuration message may be in response to the one or more capability messages, or based on an autonomous determination by network entity 105-a.

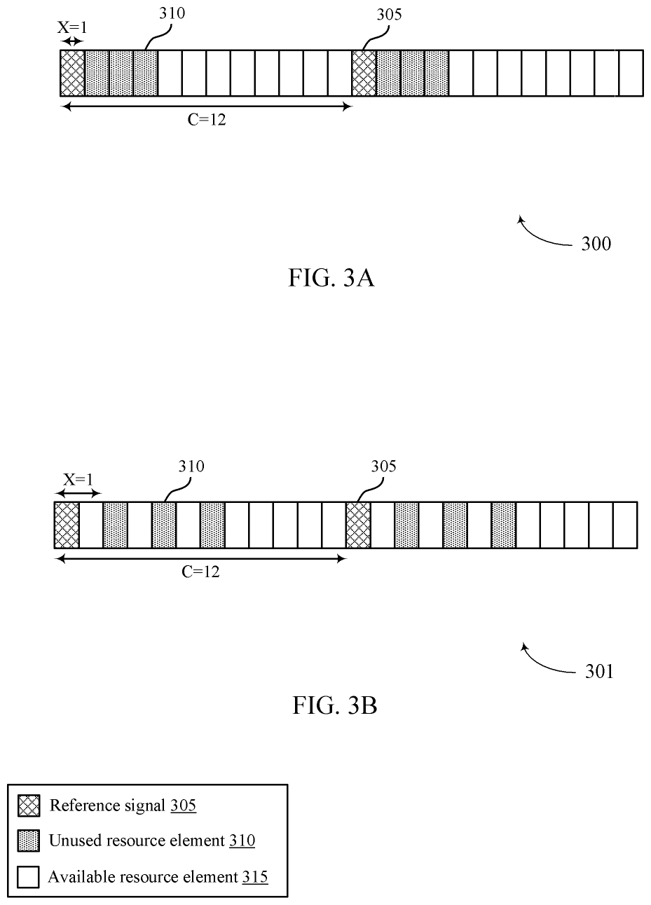

FIGS. 3A and 3B illustrate examples of rate-matching patterns 300 and 301, respectively, that support channel sounding techniques for reduced baseband bandwidth devices in accordance with one or more aspects of the present disclosure. The rate-matching patterns 300 and 301 may be implemented by a network entity and/or UE, which may be examples of a network entity 105 and a UE 115 as described with reference to FIGS. 1 and 2. In some cases, a network entity may configure a signal in accordance with FIG. 2 and may rate-match around unused resource elements in accordance with rate-matching patterns 300, 301, or both. Additionally, or alternatively, other wireless devices, such as a network node, a UE 115, etc., may implement a same or similar rate matching procedure in accordance with the patterns.

As described with reference to FIG. 2, a network entity may transmit a signal to a UE, where the signal includes a set of reference signals arranged in accordance with a comb pattern (e.g., a comb value (C)) to support down conversion at a receiving UE. In some cases, the network entity may determine whether to rate match other downlink transmissions (e.g., shared channel transmissions such as a PDSCH) in the resource elements between the combed reference signals. So as not to impact the down conversion procedure, the network entity may rate-match other downlink transmissions around M−1 empty resource elements (e.g., per port) between two combed reference signals.

The network entity may rate match in accordance with a rate-matching pattern. In some implementations, the rate matching pattern may support one used comb (e.g., a reference signal 305) and the adjacent M−1 unused resource elements 310 (e.g., subcarriers) being consecutive over M subcarriers, as depicted in FIG. 3A. Accordingly, the network entity may refrain from occupying M−1 resource elements 310 adjacent to the reference signal 305 but may rate match in other available resource elements 315. For example, as depicted in FIG. 3A, M may equal four and C may equal 12, and the frequency interval, X, may be equal to one. In such cases, the network entity may rate match in available resource elements 315 occurring three resource elements (e.g., M−1 resource elements) after the combed reference signal 305.

In some implementations, the rate matching pattern may support one used comb (e.g., a reference signal 305) and M−1 unused resource elements 310 (e.g., subcarriers) following the used comb having an equal frequency interval, X, as depicted in FIG. 3B. Accordingly, the network entity may refrain from occupying M−1 resource elements 310 that are arranged based on the frequency interval but may rate match in other available resource elements 315, or, the network entity may also refrain from occupying the interval resource elements of the M−1 unused resource elements 310 but may rate match in other available resource elements. For example, as depicted in FIG. 3B, M may equal four and C may equal 12, and the frequency interval, X, may be equal to two. In such cases, the network entity may rate match in available resource elements 315 occurring in between and/or after the unused M−1 resource elements 310. In some cases, the rate-matching may be defined with an associated ZP-CSI-RS.

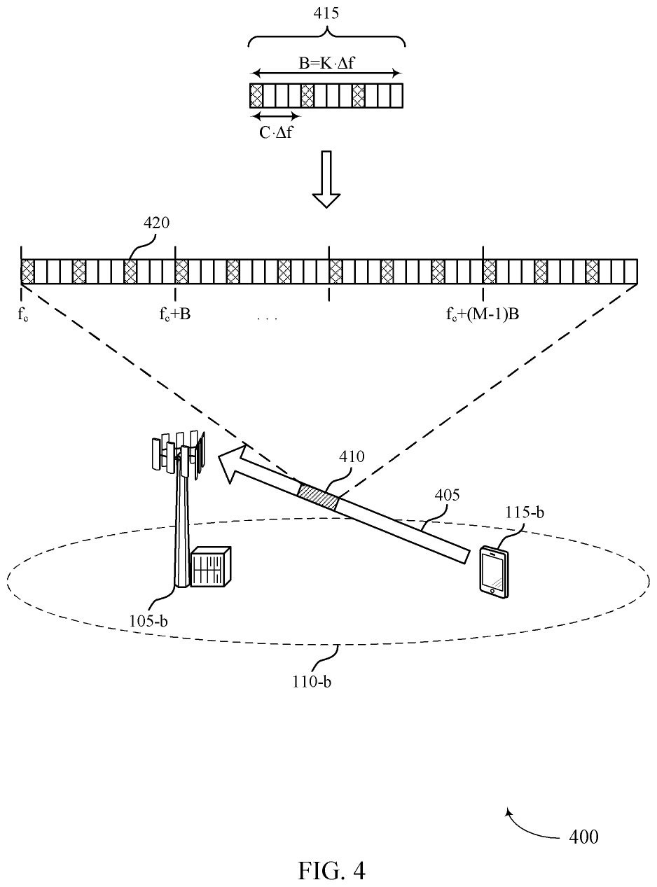

FIG. 4 illustrates an example of a wireless communications system 400 that supports channel sounding techniques for reduced baseband bandwidth devices in accordance with one or more aspects of the present disclosure. The wireless communications system 400 may include network entity 105-b and UE 115-b, which may be examples of a network entity 105 and a UE 115 as described with reference to FIGS. 1 through 3B. Network entity 105-b may serve a geographic coverage area 110-b. In some cases, UE 115-b may implement an up conversion procedure to transmit a signal in accordance with a baseband capability of UE 115-b. Additionally, or alternatively, other wireless devices, such as a network node, a network entity 105, etc., may implement a same or similar up conversion procedure.

In some wireless communications systems, such as wireless communications system 400, a UE 115 may be configured to support a baseband bandwidth that is smaller than a system bandwidth (e.g., a bandwidth supported by a network entity 105-a) so as to conserve power and reduce cost of UE 115-b. However, as described herein, for a UE 115 with smaller bandwidth capability than the system bandwidth, scheduling efficiency may be decreased if the UE's data transmissions are limited within a (semi-)fixed narrow BW. Although some systems support dynamic BWP switching and cross-BWP scheduling, the UE 115 may not be configured to monitor the other parts of the system bandwidth other than that which corresponds to the UE's baseband bandwidth. Therefore, even if the UE 115 could participate in BWP switching, the UE 115 may not be able to identify the channel quality of the system bandwidth outside the baseband bandwidth because the UE 115 is not required to transmit SRSs outside the active BWP.

Accordingly, UE 115-b may be configured to support channel sounding techniques to be performed by UE 115-b and/or network entity 105-b when UE 115-b is configured with a baseband bandwidth smaller than the system bandwidth. In uplink scenarios, such as that depicted in FIG. 4, UE 115-b may transmit a signal 410 (e.g., via communication link 405) including one or more reference signals 420 (e.g., SRSs) over the system bandwidth (e.g., a radio frequency bandwidth, a bandwidth support by network entity 105-b, a transmission bandwidth and/or receiving bandwidth support by UE 115-b). However, because the system bandwidth is larger than the baseband bandwidth supported by UE 115-b, the UE 115-b may be configured to upconvert the baseband payload 415 including a set of references signals 420 to the system BW.

The baseband bandwidth may be equal to an integer multiplied by the SCS (e.g., B=KΔf, where Δf is representative of the SCS) and the baseband bandwidth may fit into the system bandwidth M times. Accordingly, the system bandwidth is equal to the integer multiple multiplied by the baseband bandwidth (e.g., M*B). Accordingly, UE 115-b may generate a baseband payload including a set of one or more reference signals 420 arranged in accordance with a comb pattern. UE 115-b may then upconvert the baseband payload by repeating the baseband payload until system bandwidth is filled with repetitions of the baseband payload. For example, the system bandwidth may be four times the baseband bandwidth capability of UE 115-b (e.g., M, as described with reference to FIG. 2, is equal to four). For example, UE 115-b may generate the baseband payload including a set of one or more reference signals 420 and may then repeat (e.g., multiply) the baseband payload four times in accordance with M. UE 115-b may arrange the repetitions adjacently to one another to fill the system BW. UE 115-b may then transmit the repetitions of the baseband payload over the system BW, where each of the repetitions of the baseband payload include the set of one or more reference signals 420 arranged in accordance with the comb pattern. Network entity 105-b may receive the signal 410 and may perform a same or similar down conversion procedure as that described with reference to FIG. 2, such as if the baseband bandwidth capability of network entity 105-b is less than the system BW. In some other cases, the baseband bandwidth capability of network entity 105-b may be equal to or greater than the system bandwidth over which the signal 410 was transmitted. In such cases, network entity 105-b may receive and process the signal 410 in full. Network entity 105-a may use the received signal over the system bandwidth to perform channel sounding. In some cases, network entity 105 may indicate for UE 115-b to switch BWPs based on the channel sounding. Additionally, or alternatively, network entity 105-b may indicate results of the channel sounding to UE 115-b and UE 115-b may determine to switch BWPs.

The comb value (e.g., frequency interval) applied to the reference signals may be configured to satisfy C≥M. In some cases, for the unused C−1 subcarriers between two used combs for reference signals, M−1 of them may be left unoccupied by other transmissions (e.g., non-reference signals transmissions). For example, UE 115-b may refrain from occupying a number of subcarriers between each reference signal based on the integer multiple, where the number of subcarriers left unoccupied may be equal to the integer multiple minus one.

In some implementations, prior to performing up conversion, UE 115-b may determine and/or be configured to transmit one or more capability messages to network entity 105-b. UE 115-b may indicate, via the one or more capability messages, the baseband bandwidth capability of UE 115-b such as the baseband bandwidth support by UE 115-b, or whether the supported baseband bandwidth is less than the system BW, or a combination thereof. In some cases, UE 115-b may indicate, via the one or more capability messages, whether the UE 115-b supports up conversion of a baseband payload to a system bandwidth. UE 115-b may transmit the one or more capability messages upon connecting with network entity 105-b, such as via RRC signaling, or some other control signaling. In some cases, UE 115-b may transmit the capability upon request by network entity 105-b or UE 115-b may autonomously determine to transmit the one or more capability messages, via RRC, MAC-CE, UCI, etc.

In some implementations, network entity 105-b may transmit (e.g., via an RRC message, MAC-CE message, DCI message) a configuration message to UE 115-b. In some cases, the configuration message may indicate that UE 115-b is to upconvert the baseband payload to the system bandwidth. In some cases, the configuration message may indicate the multiple M, the comb value, the system BW, etc. In some cases, UE 115-b may determine the multiple M (e.g., and thus the number of analog carriers), the comb value, the system BW, etc. based on the configuration message, and/or based on a calculation by UE 115-b. In some cases, the configuration message (e.g., or triggering message) may indicate that UE 115-b is to transmit the one or more reference signals 420, where the one or more reference signals may be periodically configured (e.g., RRC configured periodic SRS) or dynamically configured (e.g., aperiodic or semi-persistent SRS). The configuration message may be in response to the one or more capability messages, or based on an autonomous determination by network entity 105-b.

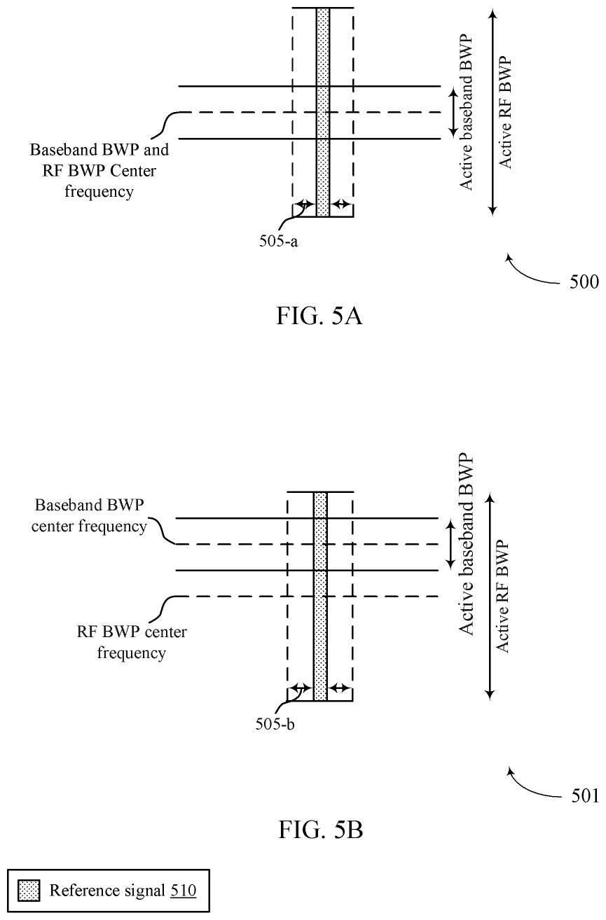

FIGS. 5A and 5B illustrate examples of frequency configurations 500 and 501, respectively, that support channel sounding techniques for reduced baseband bandwidth devices in accordance with one or more aspects of the present disclosure. The frequency configurations 500 and 501 may be implemented by a network entity and/or UE, which may be examples of a network entity 105 and a UE 115 as described with reference to FIGS. 1 through 4. In some cases, a network entity, the UE, or both may be configured with switching gaps based on frequency configurations 500 and 501.

As described herein, a UE may be configured with a baseband bandwidth that corresponds to an active baseband BWP that is less than a system bandwidth (e.g., radio frequency BW). In such cases, the system bandwidth may have a same center frequency as the active baseband BWP, as depicted with reference to FIG. 5A. In some cases, the system bandwidth and the active baseband BWP may have different center frequencies, as depicted with reference to FIG. 5B.

As a reference signal 510 (e.g., CSI-RS, SRS) may be transmitted and/or received over a wideband, as described herein for improved channel sounding, such as over a system bandwidth larger than a baseband bandwidth of the transmitting and/or receiving device, a device with a lower baseband bandwidth capability than the system bandwidth (e.g., a UE), may be configured with a switching gap 505. The switching gap 505 may be configured before and/or after a reference signal 510 for switching between an active baseband BWP (e.g., a narrowband equal to the baseband BW) and the active system BWP (e.g., a BWP corresponding to the system BW). For example, the switching gap 505 may be a measurement gap when the device is receiving reference signals 510, such as CSI-RSs, where the device may switch, during a measurement gap prior to a reference signal, from monitoring the active baseband bandwidth to monitoring the active system bandwidth to receive the reference signal. After the reference signal, the device may switch, during a measurement gap, from monitoring the active system bandwidth to monitoring the active baseband bandwidth to receive signals other than the set of reference signals (e.g., data signals or control signals rate matched around the reference signal).

In another example, the switching gap 505 may be transmission gap when the device is transmitting reference signals 510, such as SRSs, where the device may switch, during a transmission gap prior to a reference signal 510, from transmitting over the active baseband bandwidth to transmitting over the active system bandwidth to transmit a reference signal. After the reference signal, the device may switch, during a transmission gap, from transmitting over the active system bandwidth to transmitting over the active baseband bandwidth to transmit signals other than reference signals (e.g., data signals or control signals rate matched around the reference signal).

In some cases, the switching gap may be based on the frequency configurations 500 and 501. For example, the switch gap may be based on whether a center frequency of the active baseband bandwidth is equivalent to a center frequency of the active system bandwidth. In some cases, the switch gap 505 may be larger if the center frequencies are not equivalent. For example, switch gap 505-a may be smaller than 505-b. The switch gap 505 may configured on a symbol level, slot level, etc.

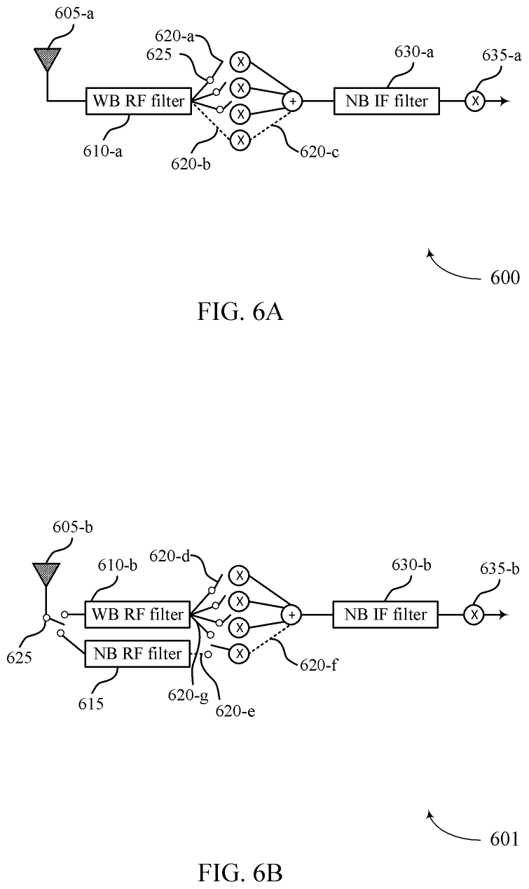

FIGS. 6A and 6B illustrate examples of radio frequency architectures 600 and 601, respectively, that support channel sounding techniques for reduced baseband bandwidth devices in accordance with one or more aspects of the present disclosure. The radio frequency architectures 600 and 601 may be implemented by a network entity and/or UE, which may be examples of a network entity 105 and a UE 115 as described with reference to FIGS. 1 through 5B. In some cases, a network entity, the UE, or both may be configured to convert analog signals to digital signals using one or both of radio frequency architectures 600 and 601.

As described herein, signals may be classified as different types, such as an analog signal and a digital signal. The data or information that is perceived in the world exists in analog form while wireless communication devices such as a UE, network entity, etc. may perceive a data signals in the digital domain. The difference between analog and digital signals is that in analog technology, information is translated into electric pulses of varying amplitude. In digital technology, translation of information is into binary format (zero or one) where each bit is representative of two distinct amplitudes. Accordingly, a receiving device may receive an analog signal and may then filter and convert the analog signal to a digital signal via an analog to digital converter (ADC) to identify information in the signal. Similarly, a transmitting device may generate a digital signal and convert the digital signal to an analog signal via a digital to analog converter (DAC) for transmission.

Some wireless communication devices include circuitry such as radio frequency front end (RFFE) architecture that is responsible for converting information from the near-zero frequency baseband signals used to convey information and data to radio-signals that can be received or transmitted over the air. Such circuitry may include one or more filters for filtering a signal, such as a wideband radio frequency filter 610, a narrowband radio frequency filter 615, or both. For example, the architecture depicted in FIG. 6A includes a wideband radio frequency filter 610-a and the architecture depicted in FIG. 6B includes a wideband radio frequency filter 610-b and a narrowband radio frequency filter 615.

In some cases, a receiving device (e.g., a UE, a network entity) may receive a signal via a receiver 605 (e.g., receiver 605-a, receiver 605-b) and may apply one or more of the filters to the received signal based on the frequency associated with the signal. For example, with reference to FIG. 6B, a receiving device may apply the wideband radio frequency filter 610-b to wideband signals such as reference signals, and apply the narrowband radio frequency filter 615 to narrowband signals. In some cases, the receiving device may operate the wideband radio frequency filter 610-b and the narrowband radio frequency filter 615 simultaneously. However, with reference to FIG. 6A, the receiving device may apply a wideband radio frequency filter 610-a regardless of whether the received signal is a wideband signal (e.g., a reference signal) or a narrowband signal.

Upon filtering the received signal, the receiving device such as a UE as described with reference to FIG. 2, may perform staggered down conversion to an intermediate frequency, where the paths 620 (e.g., an analog carrier such as −fc, −fc−(B−Δf), −fc−2(B−Δf), . . . , and −fc−(M−1)(B−Δf)) involved in the down conversion may be based on frequency of the signal, where each path 62 may represent a different analog carrier. For example, with reference to FIG. 6A, the receiving device may use all paths 620 (e.g., solid and dashed paths as depicted in FIG. 6A, such as paths 620-a, 620-b, and 620-c) in accordance with M as described with reference to FIG. 2 when the received signal is a wideband signal (by switching on all switches 625). Path 620-a may represent −fc, the path 620 below path 620-a may represent −fc−(B−Δf), and so on such that path 620-b may represent −fc−(M−1)(B−Δf). However, the receiving device may only use path 620-b and 620-c when the received signal is a narrowband signal (by switching off all switches 625). In another example, with reference to FIG. 6B, the receiving device may use all paths 620 minus path 620-e (e.g., solid and dashed paths as depicted in FIG. 6B, such as paths 620-d, and 620-f) in accordance with M as described with reference to FIG. 2 when the received signal is a wideband signal (by switching a switch 625 to 610-b, switching the corresponding down-conversion to 620-g (to complete path 620-g and 620-f), and switching on all other switches). Path 620-d may represent −fc, the path 620 below path 620-d may represent −fc−(B−Δf), and so on such that path 620-f may represent −fc−(M−1)(B−Δf). However, the receiving device may only use path 620-e and 620-f when the received signal is a narrowband signal (by switching 625 to 615, switching the corresponding down-conversion to 620-e (to complete path 620-e and 620-f), and, in some cases, switching off all other switches).

In some cases, one or both of the radio frequency architectures 600 and 601 may include a number of switches 625 (e.g., on/off switches), where the switches 625 may be single-path switches 625, or multi-path switches 625. For example, with reference to FIG. 6A, one or more of the paths 620, such as the paths used for wideband signals (e.g., the solid line paths 620) may include a switch 625. Accordingly, upon receiving a narrowband signal, the receiving device or some other entity may turn off the switches 625 of the wideband paths 620. Similarly, if the switches 625 are off upon receiving a wideband signal, the receiving device or some other entity may turn on the switches 625. In another example, with reference to FIG. 6B, one or more of the paths 620 may be associated with a multi-path switch 625 for switching between the wideband radio frequency filter 610-b and the narrowband radio frequency filter 615, and switching between paths 620 based on the frequency of the received signal.

Upon performing down conversion, the receiving device may apply another filter to the signal, such as a narrowband IF filter 630 (e.g., narrowband IF filter 630-a, and narrowband IF filter 630-b). The receiving device may then downconvert the signal to the baseband bandwidth at 635 (e.g., at 635-a and 635-b). Upon downconverting the signal to the baseband BW, the receiving device may apply an anti-aliasing filter, and then apply an ADC to obtain the digital signal.

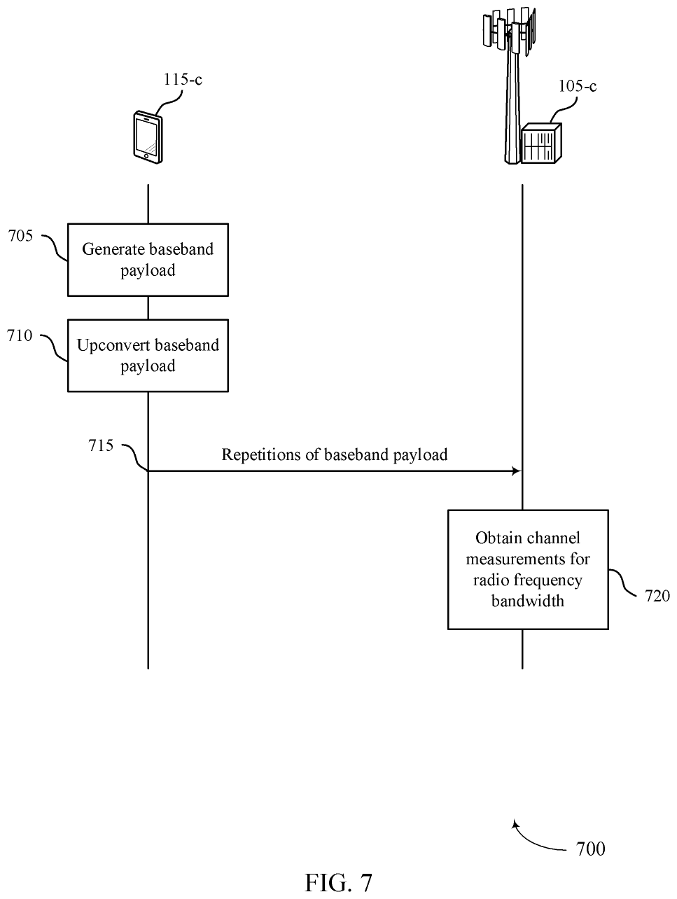

FIG. 7 illustrates an example of a process flow 700 that supports channel sounding techniques for reduced baseband bandwidth devices in accordance with one or more aspects of the present disclosure. The process flow 700 may illustrate an example bandwidth upconversion procedure performed by a UE 115. Network entity 105-c and UE 115-c may be examples of the corresponding wireless devices described with reference to FIGS. 1 through 6B. In some cases, instead of UE 115-c implementing the upconversion procedure, a different type of wireless device (e.g., a network node, a network entity 105) may perform a same or similar upconversion procedure. Alternative examples of the following may be implemented, where some steps are performed in a different order than described or are not performed at all. In some cases, steps may include additional features not mentioned below, or further steps may be added.

At 705, UE 115-c may generate a baseband payload including a set of one or more reference signals arranged in accordance with a comb pattern, where the baseband payload may be associated with a baseband bandwidth of UE 115-c. UE 115-c may receive, from network entity 105-c, a configuration message including an indication of the comb pattern for UE 115-c to apply to the set of one or more reference signals. UE 115-c may receive, from network entity 105-c, a message indicating for UE 115-c to generate the baseband payload and upconvert the baseband payload by repeating the baseband payload until the radio frequency bandwidth is filled with the repetitions of the baseband payload.

In some cases, UE 115-c may transmit, to network entity 105-c, a capability message indicative that UE 115-c supports the baseband bandwidth that is less than the radio frequency bandwidth, where generating the baseband payload and upconverting the baseband payload may be based on the capability message. In some cases, UE 115-c may transmit, to network entity 105-c, a capability message indicative that UE 115-c is capable of upconverting the baseband payload by repeating the baseband payload until the radio frequency bandwidth is filled with repetitions of the baseband payload.

Generating the baseband payload may include arranging the set of one or more reference signals in accordance with the comb pattern based on a number of repetitions of the baseband payload to fill the radio frequency bandwidth, where a comb value associated with the comb pattern is greater than or equal to the number of repetitions.

At 710, UE 115-c may upconvert the baseband payload by repeating the baseband payload until a radio frequency bandwidth larger than the baseband bandwidth is filled with repetitions of the baseband payload.

At 715, UE 115-c may transmit the repetitions of the baseband payload over the radio frequency bandwidth, where each of the repetitions of the baseband payload may include the set of one or more reference signals arranged in accordance with the comb pattern.

In some cases, UE 115-c may switch, during a transmission gap prior to a reference signal of the set of one or more reference signals, from transmitting over a narrowband bandwidth equal to the baseband bandwidth to transmitting over the radio frequency bandwidth to transmit a reference signal from the set of one or more reference signals. In some cases, UE 115-c may switch, during a transmission gap after a reference signal of the set of one or more reference signals, from transmitting over the radio frequency bandwidth to transmitting over a narrowband bandwidth equal to the baseband bandwidth to transmit signals other than the set of one or more reference signals. A transmission gap for switching between transmitting over a narrowband bandwidth equal to the baseband bandwidth or the radio frequency bandwidth may be based on whether a center frequency of the baseband bandwidth is equivalent to a center frequency of the radio frequency bandwidth. In some implementations, a center frequency of a narrowband bandwidth equal to the baseband bandwidth is equivalent to a center frequency of the radio frequency bandwidth. In some implementations, a center frequency of a narrowband bandwidth equal to the baseband bandwidth is different from a center frequency of the radio frequency bandwidth.

At 720, network entity 105-d may obtain channel measurements for the radio frequency bandwidth using the set of reference signals.

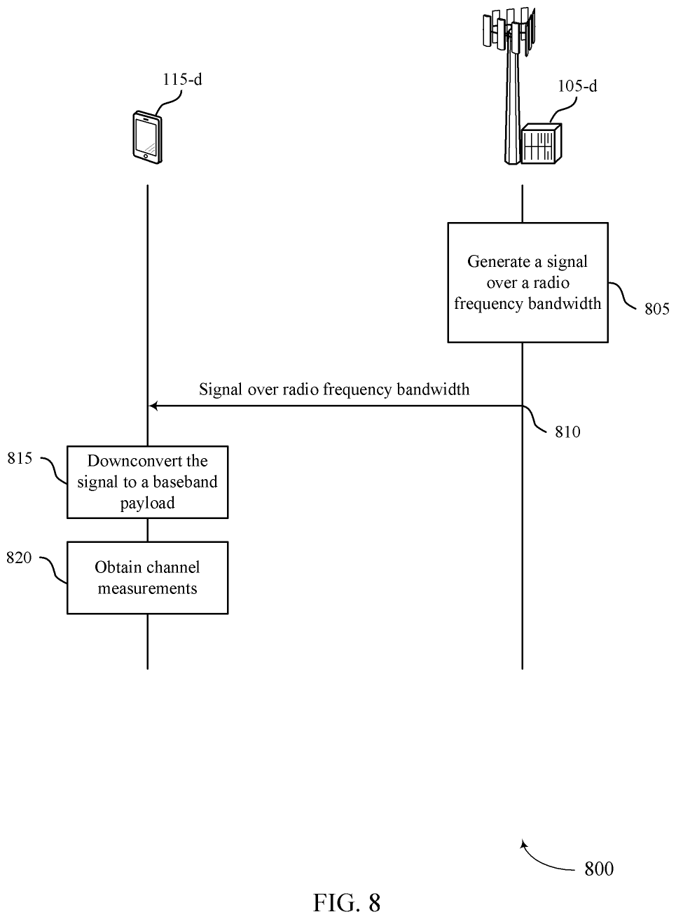

FIG. 8 illustrates an example of a process flow 800 that supports channel sounding techniques for reduced baseband bandwidth devices in accordance with one or more aspects of the present disclosure. The process flow 800 may illustrate an example bandwidth down conversion procedure performed by a UE 115. Network entity 105-d and UE 115-d may be examples of the corresponding wireless devices described with reference to FIGS. 1 through 7. In some cases, instead of UE 115-d implementing the down conversion procedure, a different type of wireless device (e.g., a network node, a network entity 105) may perform a same or similar down conversion procedure. Alternative examples of the following may be implemented, where some steps are performed in a different order than described or are not performed at all. In some cases, steps may include additional features not mentioned below, or further steps may be added.

At 805, network entity 105-d may generate, over a radio frequency bandwidth, a signal including a set of reference signals arranged in accordance with a comb pattern based on a baseband bandwidth capability of UE 115-d.

In some implementations, generating the signal may include arranging a measurement gap before and after each reference signal of the set of reference signals, where the measurement gap may be based on whether a center frequency of a narrowband bandwidth equal to a baseband bandwidth of UE 115-d is equivalent to a center frequency of the radio frequency bandwidth. In some implementations, generating the signal may include arranging the set of reference signals in accordance with the comb pattern based on a number of repetitions of a baseband payload of UE 115-d to fill the radio frequency bandwidth, where a comb value associated with the comb pattern may be greater than or equal to the number of repetitions.

In some cases, generating the signal may include refraining from occupying a number of subcarriers between each reference signal of the set of reference signals based on an integer multiple of a baseband bandwidth of UE 115-d to the radio frequency bandwidth, where the number of subcarriers left unoccupied may be equal to the integer multiple minus one. The unoccupied subcarriers are adjacent to one another, or are arranged in accordance with a frequency interval based on a rate matching pattern.

At 810, UE 115-d may receive, over a radio frequency bandwidth, a signal that includes a set of reference signals arranged across the radio frequency bandwidth in accordance with a comb pattern. The set of reference signals may be arranged in accordance with the comb pattern based on a result of dividing the radio frequency bandwidth by the baseband bandwidth, where a comb value associated with the comb pattern may be greater than or equal to the result. A number of subcarriers between each reference signal of the set of reference signals may be unoccupied based on an integer multiple of the baseband bandwidth to the radio frequency bandwidth, and the number of subcarriers left unoccupied may be equal to the integer multiple minus one. The unoccupied subcarriers may be adjacent to one another, or are arranged in accordance with a frequency interval based on a rate matching pattern.

In some cases, UE 115-d may transmit, to network entity 105-d, a capability message indicative that UE 115-d supports the baseband bandwidth that is less than the radio frequency bandwidth, where the signal may be based on the capability message. In some cases, UE 115-d may transmit, to network entity 105-d, a capability message indicative that the UE is capable of downconverting the signal from the radio frequency bandwidth to the baseband payload associated with the baseband bandwidth of the UE, where receiving the signal may be based on the capability message.

In some cases, UE 115-d may receive a second signal over a narrowband bandwidth and may apply a wideband filter to the signal received over the radio frequency bandwidth. The second signal may be received over the narrowband bandwidth, or both regardless of the respective bandwidths of the signal and the second signal. In some cases, UE 115-d may receive a second signal over a narrowband bandwidth and may apply a wideband filter to the signal received over the radio frequency bandwidth and a narrowband filter to the second signal received over the narrowband bandwidth based on the respective bandwidths of the signal and the second signal.

In some cases, UE 115-d may switch, during a measurement gap prior to a reference signal of the set of reference signals, from monitoring a narrowband bandwidth equal to the baseband bandwidth to monitoring the radio frequency bandwidth to receive the reference signal. In some cases, UE 115-d may switch, during a measurement gap after a reference signal of the set of reference signals, from monitoring the radio frequency bandwidth to monitoring a narrowband bandwidth equal to the baseband bandwidth to receive signals other than the set of reference signals. A measurement gap for switching between monitoring the baseband bandwidth or the radio frequency bandwidth may be based on whether a center frequency of a narrowband bandwidth equal to the baseband bandwidth is equivalent to a center frequency of the radio frequency bandwidth. In some cases, a center frequency of a narrowband bandwidth equal to the baseband bandwidth may be equivalent to a center frequency of the radio frequency bandwidth. In some cases, a center frequency of a narrowband bandwidth equal to the baseband bandwidth may be different from a center frequency of the radio frequency bandwidth.

At 815, UE 115-d may downconvert the signal from the radio frequency bandwidth to a baseband payload associated with a baseband bandwidth of the UE. The baseband bandwidth may be smaller than the radio frequency bandwidth, and the baseband payload may include, as a result of the downconverting, a subset of reference signals of the set of reference signals. The subset of reference signals may be representative of the radio frequency bandwidth. Downconverting the signal may include aligning a number of analog carriers of the signal in a staggered configuration resulting in the baseband payload including the subset of reference signals representative of the radio frequency bandwidth, where the number of analog carriers may be equal to the radio frequency bandwidth divided by the baseband bandwidth.

In some cases, UE 115-d may receive a message indicating for UE 115-d to downconvert the signal from the radio frequency bandwidth to the baseband payload associated with the baseband bandwidth of UE 115-d.

At 820, UE 115-d may obtain channel measurements for the radio frequency bandwidth using the subset of reference signals included in the baseband payload based on the subset of reference signals being representative of the radio frequency bandwidth.

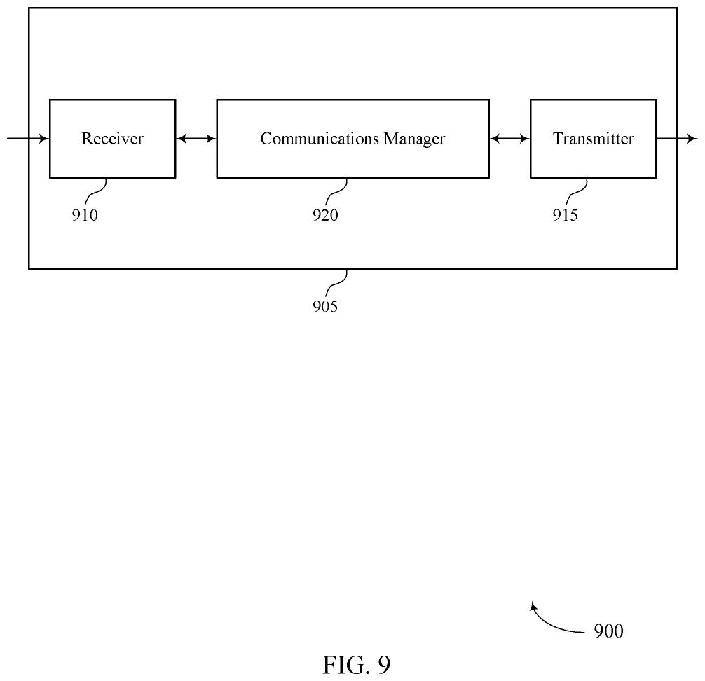

FIG. 9 shows a block diagram 900 of a device 905 that supports channel

sounding techniques for reduced baseband bandwidth devices in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to channel sounding techniques for reduced baseband bandwidth devices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to channel sounding techniques for reduced baseband bandwidth devices). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of channel sounding techniques for reduced baseband bandwidth devices as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. For example, the communications manager 920 may be configured as or otherwise support a means for generating a baseband payload including a set of one or more reference signals arranged in accordance with a comb pattern, where the baseband payload is associated with a baseband bandwidth of the UE. The communications manager 920 may be configured as or otherwise support a means for upconverting the baseband payload by repeating the baseband payload until a radio frequency bandwidth larger than the baseband bandwidth is filled with repetitions of the baseband payload. The communications manager 920 may be configured as or otherwise support a means for transmitting the repetitions of the baseband payload over the radio frequency bandwidth, each of the repetitions of the baseband payload including the set of one or more reference signals arranged in accordance with the comb pattern.

Additionally, or alternatively, the communications manager 920 may support wireless communications at a UE in accordance with examples as disclosed herein. For example, the communications manager 920 may be configured as or otherwise support a means for receiving, over a radio frequency bandwidth, a signal that includes a set of reference signals arranged across the radio frequency bandwidth in accordance with a comb pattern. The communications manager 920 may be configured as or otherwise support a means for downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth. The communications manager 920 may be configured as or otherwise support a means for obtaining channel measurements for the radio frequency bandwidth using the subset of reference signals included in the baseband payload based on the subset of reference signals being representative of the radio frequency bandwidth.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption, and more efficient utilization of communication resources.

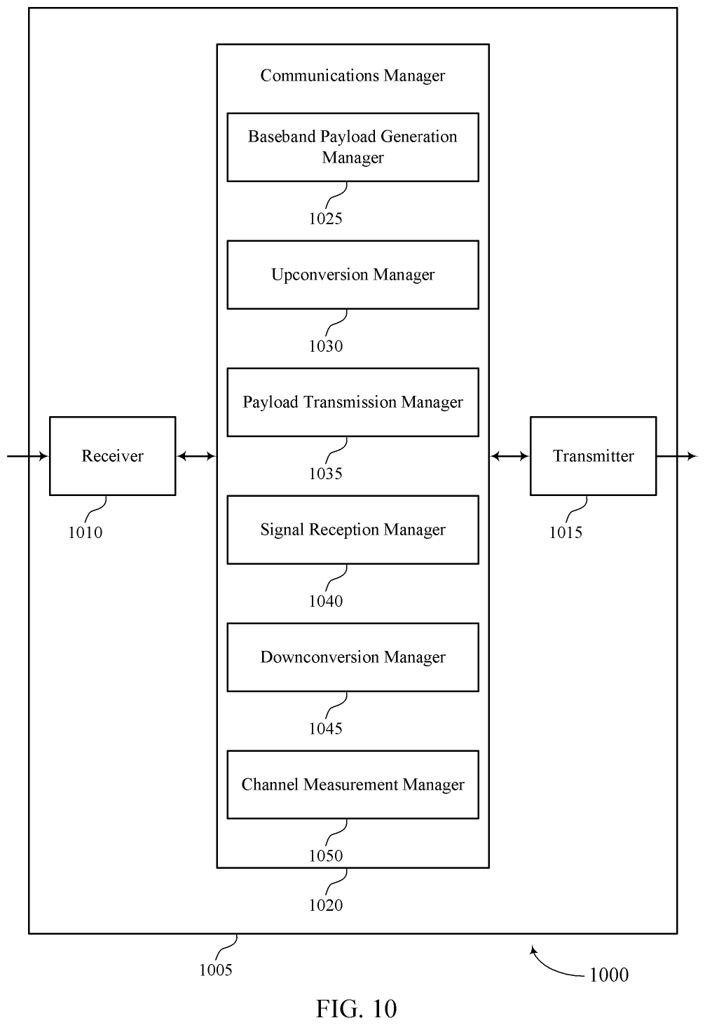

FIG. 10 shows a block diagram 1000 of a device 1005 that supports channel sounding techniques for reduced baseband bandwidth devices in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to channel sounding techniques for reduced baseband bandwidth devices). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to channel sounding techniques for reduced baseband bandwidth devices). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of channel sounding techniques for reduced baseband bandwidth devices as described herein. For example, the communications manager 1020 may include a baseband payload generation manager 1025, an upconversion manager 1030, a payload transmission manager 1035, a signal reception manager 1040, a downconversion manager 1045, a channel measurement manager 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The baseband payload generation manager 1025 may be configured as or otherwise support a means for generating a baseband payload including a set of one or more reference signals arranged in accordance with a comb pattern, where the baseband payload is associated with a baseband bandwidth of the UE. The upconversion manager 1030 may be configured as or otherwise support a means for upconverting the baseband payload by repeating the baseband payload until a radio frequency bandwidth larger than the baseband bandwidth is filled with repetitions of the baseband payload. The payload transmission manager 1035 may be configured as or otherwise support a means for transmitting the repetitions of the baseband payload over the radio frequency bandwidth, each of the repetitions of the baseband payload including the set of one or more reference signals arranged in accordance with the comb pattern.

Additionally, or alternatively, the communications manager 1020 may support wireless communications at a UE in accordance with examples as disclosed herein. The signal reception manager 1040 may be configured as or otherwise support a means for receiving, over a radio frequency bandwidth, a signal that includes a set of reference signals arranged across the radio frequency bandwidth in accordance with a comb pattern. The downconversion manager 1045 may be configured as or otherwise support a means for downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth. The channel measurement manager 1050 may be configured as or otherwise support a means for obtaining channel measurements for the radio frequency bandwidth using the subset of reference signals included in the baseband payload based on the subset of reference signals being representative of the radio frequency bandwidth.

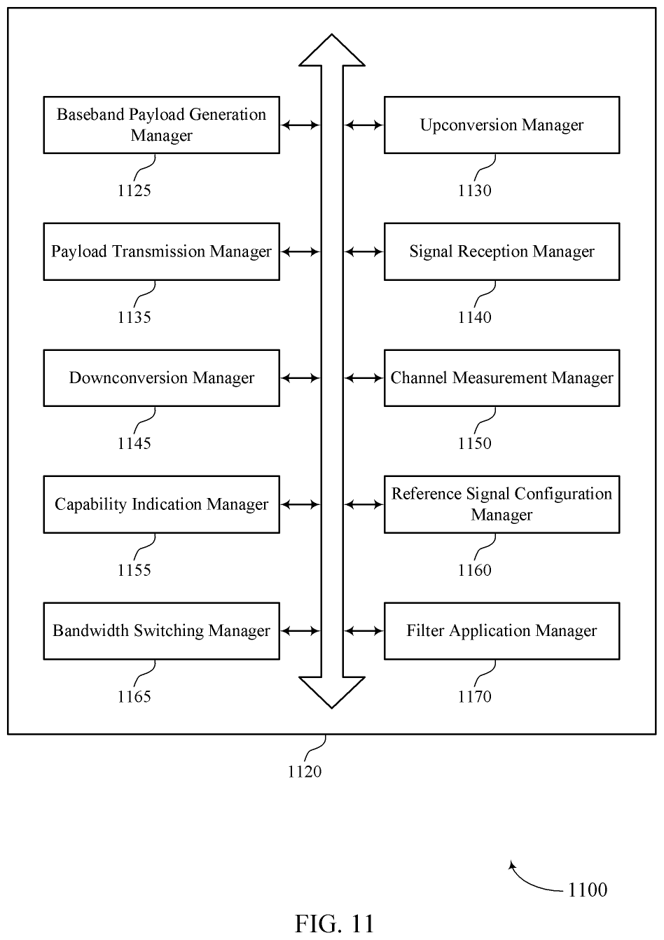

FIG. 11 shows a block diagram 1100 of a communications manager 1120 that supports channel sounding techniques for reduced baseband bandwidth devices in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of channel sounding techniques for reduced baseband bandwidth devices as described herein. For example, the communications manager 1120 may include a baseband payload generation manager 1125, an upconversion manager 1130, a payload transmission manager 1135, a signal reception manager 1140, a downconversion manager 1145, a channel measurement manager 1150, a capability indication manager 1155, a reference signal configuration manager 1160, a bandwidth switching manager 1165, a filter application manager 1170, or any combination thereof. Each of these components may communicate, directly or indirectly, with one another (e.g., via one or more buses).

The communications manager 1120 may support wireless communications at a UE in accordance with examples as disclosed herein. The baseband payload generation manager 1125 may be configured as or otherwise support a means for generating a baseband payload including a set of one or more reference signals arranged in accordance with a comb pattern, where the baseband payload is associated with a baseband bandwidth of the UE. The upconversion manager 1130 may be configured as or otherwise support a means for upconverting the baseband payload by repeating the baseband payload until a radio frequency bandwidth larger than the baseband bandwidth is filled with repetitions of the baseband payload. The payload transmission manager 1135 may be configured as or otherwise support a means for transmitting the repetitions of the baseband payload over the radio frequency bandwidth, each of the repetitions of the baseband payload including the set of one or more reference signals arranged in accordance with the comb pattern.

In some examples, the capability indication manager 1155 may be configured as or otherwise support a means for transmitting a capability message indicative that the UE supports the baseband bandwidth that is less than the radio frequency bandwidth, where generating the baseband payload and upconverting the baseband payload is based on the capability message.

In some examples, the capability indication manager 1155 may be configured as or otherwise support a means for transmitting a capability message indicative that the UE is capable of upconverting the baseband payload by repeating the baseband payload until the radio frequency bandwidth is filled with repetitions of the baseband payload.

In some examples, the reference signal configuration manager 1160 may be configured as or otherwise support a means for receiving a message including an indication of the comb pattern for the UE to apply to the set of one or more reference signals.

In some examples, the upconversion manager 1130 may be configured as or otherwise support a means for receiving a message indicating for the UE to generate the baseband payload and upconvert the baseband payload by repeating the baseband payload until the radio frequency bandwidth is filled with the repetitions of the baseband payload.

In some examples, to support generating the baseband payload, the baseband payload generation manager 1125 may be configured as or otherwise support a means for arranging the set of one or more reference signals in accordance with the comb pattern based on a number of repetitions of the baseband payload to fill the radio frequency bandwidth, where a comb value associated with the comb pattern is greater than or equal to the number of repetitions.

In some examples, the bandwidth switching manager 1165 may be configured as or otherwise support a means for switching, during a transmission gap prior to a reference signal of the set of one or more reference signals, from transmitting over a narrowband bandwidth equal to the baseband bandwidth to transmitting over the radio frequency bandwidth to transmit a reference signal from the set of one or more reference signals.

In some examples, the bandwidth switching manager 1165 may be configured as or otherwise support a means for switching, during a transmission gap after a reference signal of the set of one or more reference signals, from transmitting over the radio frequency bandwidth to transmitting over a narrowband bandwidth equal to the baseband bandwidth to transmit signals other than the set of one or more reference signals.

In some examples, a transmission gap for switching between transmitting over a narrowband bandwidth equal to the baseband bandwidth or the radio frequency bandwidth is based on whether a center frequency of the baseband bandwidth is equivalent to a center frequency of the radio frequency bandwidth.

In some examples, a center frequency of a narrowband bandwidth equal to the baseband bandwidth is equivalent to a center frequency of the radio frequency bandwidth.

In some examples, a center frequency of a narrowband bandwidth equal to the baseband bandwidth is different from a center frequency of the radio frequency bandwidth.

Additionally, or alternatively, the communications manager 1120 may support wireless communications at a UE in accordance with examples as disclosed herein. The signal reception manager 1140 may be configured as or otherwise support a means for receiving, over a radio frequency bandwidth, a signal that includes a set of reference signals arranged across the radio frequency bandwidth in accordance with a comb pattern. The downconversion manager 1145 may be configured as or otherwise support a means for downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth. The channel measurement manager 1150 may be configured as or otherwise support a means for obtaining channel measurements for the radio frequency bandwidth using the subset of reference signals included in the baseband payload based on the subset of reference signals being representative of the radio frequency bandwidth.

In some examples, the capability indication manager 1155 may be configured as or otherwise support a means for transmitting a capability message indicative that the UE supports the baseband bandwidth that is less than the radio frequency bandwidth, where the signal is based on the capability message.

In some examples, the capability indication manager 1155 may be configured as or otherwise support a means for transmitting a capability message indicative that the UE is capable of downconverting the signal from the radio frequency bandwidth to the baseband payload associated with the baseband bandwidth of the UE, where receiving the signal is based on the capability message.

In some examples, the downconversion manager 1145 may be configured as or otherwise support a means for receiving a message indicating for the UE to downconvert the signal from the radio frequency bandwidth to the baseband payload associated with the baseband bandwidth of the UE.

In some examples, to support downconverting the signal, the downconversion manager 1145 may be configured as or otherwise support a means for aligning a number of analog carriers of the signal in a staggered configuration resulting in the baseband payload including the subset of reference signals representative of the radio frequency bandwidth, where the number of analog carriers is equal to the radio frequency bandwidth divided by the baseband bandwidth.

In some examples, the signal reception manager 1140 may be configured as or otherwise support a means for receiving a second signal over a narrowband bandwidth. In some examples, the filter application manager 1170 may be configured as or otherwise support a means for applying a wideband filter to the signal received over the radio frequency bandwidth, the second signal received over the narrowband bandwidth, or both regardless of the respective bandwidths of the signal and the second signal.

In some examples, the signal reception manager 1140 may be configured as or otherwise support a means for receiving a second signal over a narrowband bandwidth. In some examples, the filter application manager 1170 may be configured as or otherwise support a means for applying a wideband filter to the signal received over the radio frequency bandwidth and a narrowband filter to the second signal received over the narrowband bandwidth based on the respective bandwidths of the signal and the second signal.

In some examples, the bandwidth switching manager 1165 may be configured as or otherwise support a means for switching, during a measurement gap prior to a reference signal of the set of reference signals, from monitoring a narrowband bandwidth equal to the baseband bandwidth to monitoring the radio frequency bandwidth to receive the reference signal.

In some examples, the bandwidth switching manager 1165 may be configured as or otherwise support a means for switching, during a measurement gap after a reference signal of the set of reference signals, from monitoring the radio frequency bandwidth to monitoring a narrowband bandwidth equal to the baseband bandwidth to receive signals other than the set of reference signals.

In some examples, a measurement gap for switching between monitoring the baseband bandwidth or the radio frequency bandwidth is based on whether a center frequency of a narrowband bandwidth equal to the baseband bandwidth is equivalent to a center frequency of the radio frequency bandwidth.

In some examples, a center frequency of a narrowband bandwidth equal to the baseband bandwidth is equivalent to a center frequency of the radio frequency bandwidth.

In some examples, a center frequency of a narrowband bandwidth equal to the baseband bandwidth is different from a center frequency of the radio frequency bandwidth.

In some examples, the set of reference signals are arranged in accordance with the comb pattern based on a result of dividing the radio frequency bandwidth by the baseband bandwidth, a comb value associated with the comb pattern is greater than or equal to the result.

In some examples, a number of subcarriers between each reference signal of the set of reference signals are unoccupied based on an integer multiple of the baseband bandwidth to the radio frequency bandwidth, the number of subcarriers left unoccupied is equal to the integer multiple minus one.

In some examples, the unoccupied subcarriers are adjacent to one another, or are arranged in accordance with a frequency interval based on a rate matching pattern.

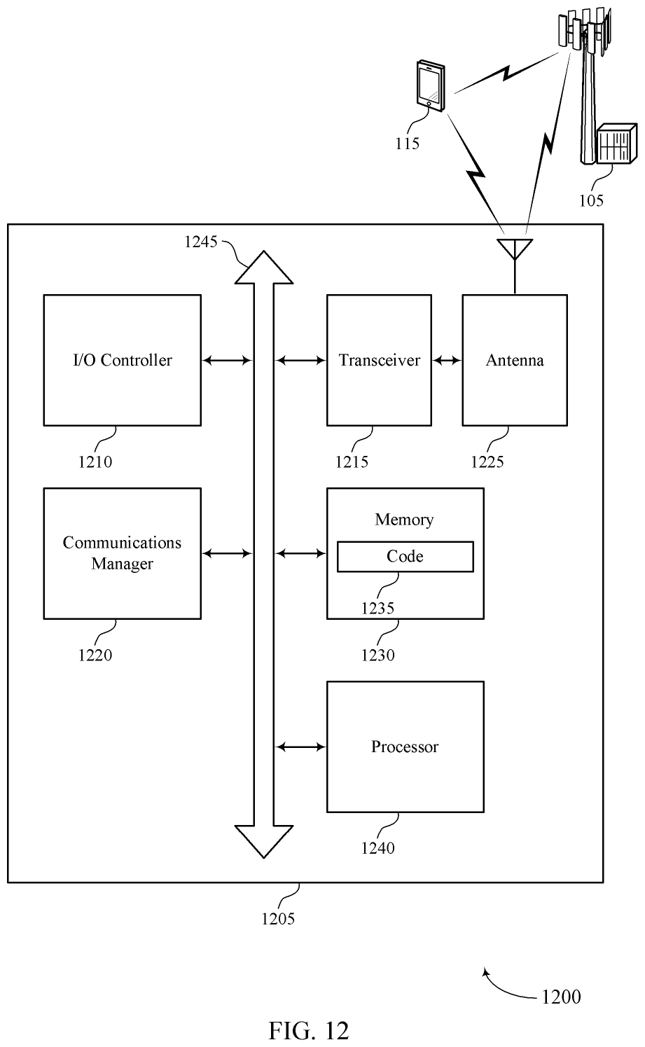

FIG. 12 shows a diagram of a system 1200 including a device 1205 that supports channel sounding techniques for reduced baseband bandwidth devices in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting channel sounding techniques for reduced baseband bandwidth devices). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for generating a baseband payload including a set of one or more reference signals arranged in accordance with a comb pattern, where the baseband payload is associated with a baseband bandwidth of the UE. The communications manager 1220 may be configured as or otherwise support a means for upconverting the baseband payload by repeating the baseband payload until a radio frequency bandwidth larger than the baseband bandwidth is filled with repetitions of the baseband payload. The communications manager 1220 may be configured as or otherwise support a means for transmitting the repetitions of the baseband payload over the radio frequency bandwidth, each of the repetitions of the baseband payload including the set of one or more reference signals arranged in accordance with the comb pattern.

Additionally, or alternatively, the communications manager 1220 may support wireless communications at a UE in accordance with examples as disclosed herein. For example, the communications manager 1220 may be configured as or otherwise support a means for receiving, over a radio frequency bandwidth, a signal that includes a set of reference signals arranged across the radio frequency bandwidth in accordance with a comb pattern. The communications manager 1220 may be configured as or otherwise support a means for downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth. The communications manager 1220 may be configured as or otherwise support a means for obtaining channel measurements for the radio frequency bandwidth using the subset of reference signals included in the baseband payload based on the subset of reference signals being representative of the radio frequency bandwidth.

By including or configuring the communications manager 1220 in accordance with examples as described herein, the device 1205 may support techniques for improved communication reliability, reduced latency, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of channel sounding techniques for reduced baseband bandwidth devices as described herein, or the processor 1240 and the memory 1230 may be otherwise configured to perform or support such operations.

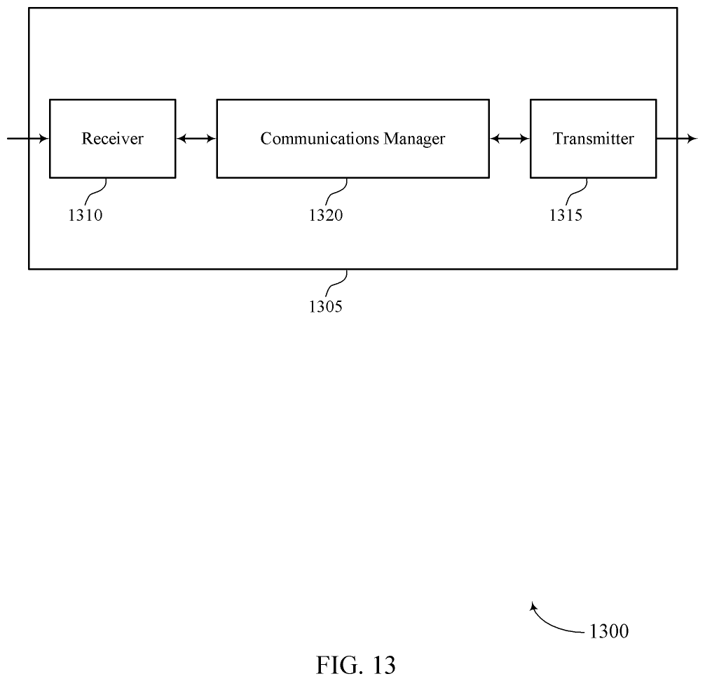

FIG. 13 shows a block diagram 1300 of a device 1305 that supports channel sounding techniques for reduced baseband bandwidth devices in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of channel sounding techniques for reduced baseband bandwidth devices as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. For example, the communications manager 1320 may be configured as or otherwise support a means for receiving, over a radio frequency bandwidth, a signal including a set of reference signals arranged across the radio frequency bandwidth in accordance with a comb pattern based on a baseband bandwidth supported by a UE. The communications manager 1320 may be configured as or otherwise support a means for obtaining channel measurements for the radio frequency bandwidth using the set of reference signals.

Additionally, or alternatively, the communications manager 1320 may support wireless communications at a network entity in accordance with examples as disclosed herein. For example, the communications manager 1320 may be configured as or otherwise support a means for generating, over a radio frequency bandwidth, a signal including a set of reference signals arranged in accordance with a comb pattern based on a baseband bandwidth capability of a UE. The communications manager 1320 may be configured as or otherwise support a means for transmitting, over the radio frequency bandwidth, the signal including the set of reference signals arranged across the radio frequency bandwidth in accordance with the comb pattern.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced power consumption, and more efficient utilization of communication resources.

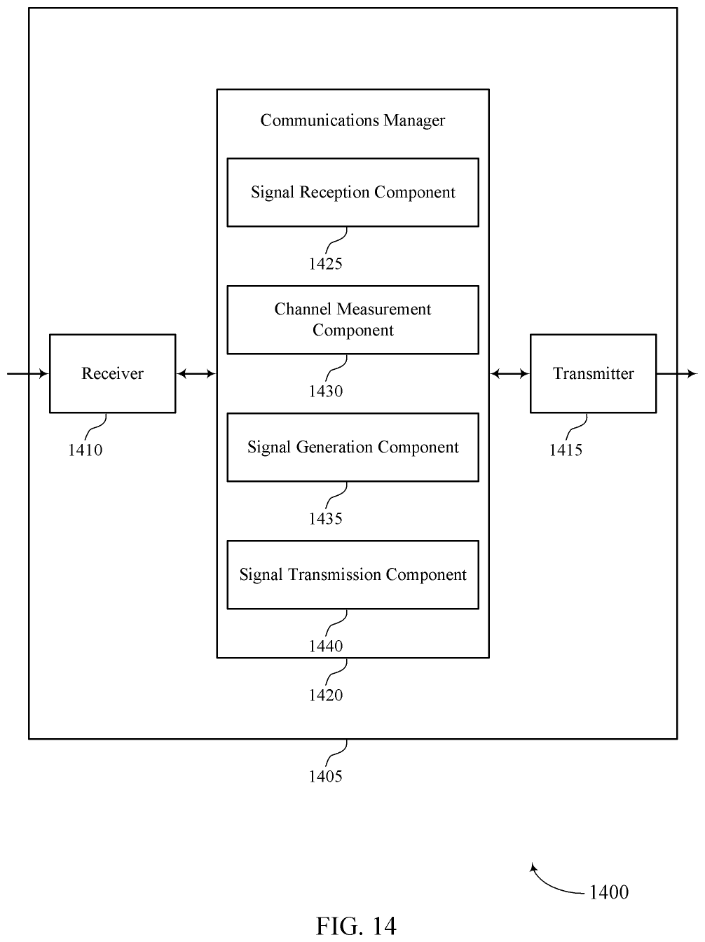

FIG. 14 shows a block diagram 1400 of a device 1405 that supports channel sounding techniques for reduced baseband bandwidth devices in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of channel sounding techniques for reduced baseband bandwidth devices as described herein. For example, the communications manager 1420 may include a signal reception component 1425, a channel measurement component 1430, a signal generation component 1435, a signal transmission component 1440, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. The signal reception component 1425 may be configured as or otherwise support a means for receiving, over a radio frequency bandwidth, a signal including a set of reference signals arranged across the radio frequency bandwidth in accordance with a comb pattern based on a baseband bandwidth supported by a UE. The channel measurement component 1430 may be configured as or otherwise support a means for obtaining channel measurements for the radio frequency bandwidth using the set of reference signals.

Additionally, or alternatively, the communications manager 1420 may support wireless communications at a network entity in accordance with examples as disclosed herein. The signal generation component 1435 may be configured as or otherwise support a means for generating, over a radio frequency bandwidth, a signal including a set of reference signals arranged in accordance with a comb pattern based on a baseband bandwidth capability of a UE. The signal transmission component 1440 may be configured as or otherwise support a means for transmitting, over the radio frequency bandwidth, the signal including the set of reference signals arranged across the radio frequency bandwidth in accordance with the comb pattern.

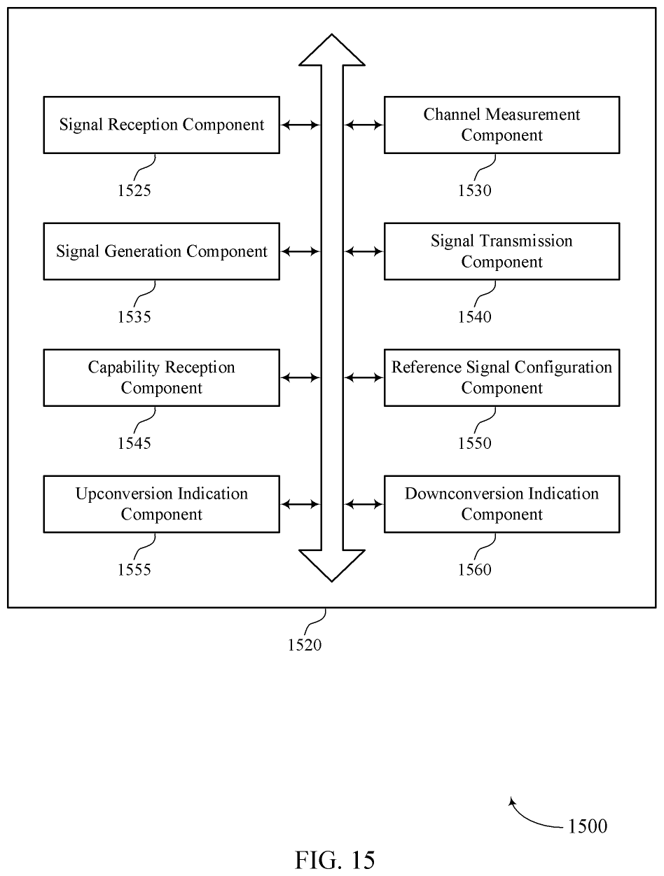

FIG. 15 shows a block diagram 1500 of a communications manager 1520 that supports channel sounding techniques for reduced baseband bandwidth devices in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of channel sounding techniques for reduced baseband bandwidth devices as described herein. For example, the communications manager 1520 may include a signal reception component 1525, a channel measurement component 1530, a signal generation component 1535, a signal transmission component 1540, a capability reception component 1545, a reference signal configuration component 1550, an upconversion indication component 1555, a downconversion indication component 1560, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a network entity in accordance with examples as disclosed herein. The signal reception component 1525 may be configured as or otherwise support a means for receiving, over a radio frequency bandwidth, a signal including a set of reference signals arranged across the radio frequency bandwidth in accordance with a comb pattern based on a baseband bandwidth supported by a UE. The channel measurement component 1530 may be configured as or otherwise support a means for obtaining channel measurements for the radio frequency bandwidth using the set of reference signals.

In some examples, the capability reception component 1545 may be configured as or otherwise support a means for receiving a capability message indicative that the UE supports the baseband bandwidth that is less than the radio frequency bandwidth, where receiving the signal is based on the capability message.

In some examples, the capability reception component 1545 may be configured as or otherwise support a means for receiving a capability message indicative that the UE is capable of upconverting a baseband payload by repeating the baseband payload until the radio frequency bandwidth is filled with repetitions of the baseband payload.

In some examples, the reference signal configuration component 1550 may be configured as or otherwise support a means for transmitting a message including an indication of the comb pattern for the UE to apply to the signal.

In some examples, the upconversion indication component 1555 may be configured as or otherwise support a means for transmitting a message indicating for the UE to generate a baseband payload and upconvert the baseband payload by repeating the baseband payload until the radio frequency bandwidth is filled with repetitions of the baseband payload.

In some examples, the set of reference signals are arranged in accordance with the comb pattern based on a number of repetitions of a baseband payload of the UE to fill the radio frequency bandwidth, a comb value associated with the comb pattern is greater than or equal to the number of repetitions.

In some examples, a number of subcarriers between each reference signal of the set of reference signals are unoccupied based on an integer multiple of the baseband bandwidth of the UE to the radio frequency bandwidth, the number of subcarriers left unoccupied is equal to the integer multiple minus one.

Additionally, or alternatively, the communications manager 1520 may support wireless communications at a network entity in accordance with examples as disclosed herein. The signal generation component 1535 may be configured as or otherwise support a means for generating, over a radio frequency bandwidth, a signal including a set of reference signals arranged in accordance with a comb pattern based on a baseband bandwidth capability of a UE. The signal transmission component 1540 may be configured as or otherwise support a means for transmitting, over the radio frequency bandwidth, the signal including the set of reference signals arranged across the radio frequency bandwidth in accordance with the comb pattern.

In some examples, the capability reception component 1545 may be configured as or otherwise support a means for receiving a capability message indicative that the UE supports a baseband bandwidth that is less than the radio frequency bandwidth, where generating the signal is based on the capability message.

In some examples, the capability reception component 1545 may be configured as or otherwise support a means for receiving a capability message indicative that the UE is capable of downconverting the signal from the radio frequency bandwidth to a baseband payload associated with a baseband bandwidth of the UE, where generating the signal is based on the capability message.

In some examples, the downconversion indication component 1560 may be configured as or otherwise support a means for transmitting a message indicating for the UE to downconvert the signal from the radio frequency bandwidth to a baseband payload associated with a baseband bandwidth of the UE.

In some examples, to support generating the signal, the signal generation component 1535 may be configured as or otherwise support a means for arranging a measurement gap before and after each reference signal of the set of reference signals, where the measurement gap is based on whether a center frequency of a narrowband bandwidth equal to a baseband bandwidth of the UE is equivalent to a center frequency of the radio frequency bandwidth.

In some examples, to support generating the signal, the signal generation component 1535 may be configured as or otherwise support a means for arranging the set of reference signals in accordance with the comb pattern based on a number of repetitions of a baseband payload of the UE to fill the radio frequency bandwidth, where a comb value associated with the comb pattern is greater than or equal to the number of repetitions.

In some examples, to support generating the signal, the signal generation component 1535 may be configured as or otherwise support a means for refraining from occupying a number of subcarriers between each reference signal of the set of reference signals based on an integer multiple of a baseband bandwidth of the UE to the radio frequency bandwidth, where the number of subcarriers left unoccupied is equal to the integer multiple minus one.

In some examples, the unoccupied subcarriers are adjacent to one another, or are arranged in accordance with a frequency interval based on a rate matching pattern.

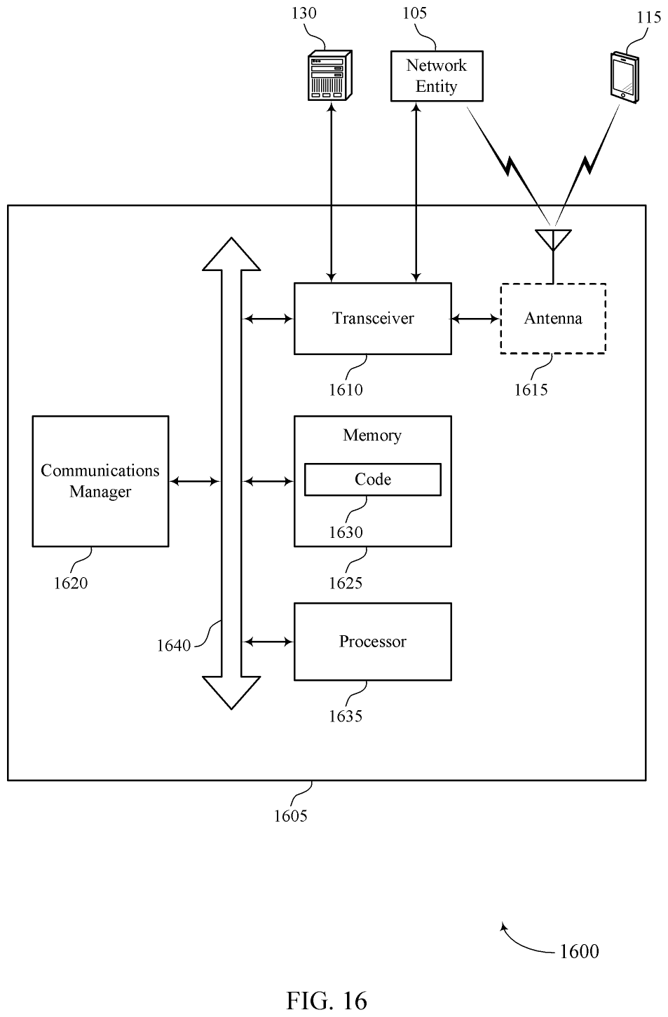

FIG. 16 shows a diagram of a system 1600 including a device 1605 that supports channel sounding techniques for reduced baseband bandwidth devices in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. The transceiver 1610, or the transceiver 1610 and one or more antennas 1615 or wired interfaces, where applicable, may be an example of a transmitter 1315, a transmitter 1415, a receiver 1310, a receiver 1410, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting channel sounding techniques for reduced baseband bandwidth devices). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-a wireless communications network technology to provide communication between network entities 105.

The communications manager 1620 may support wireless communications at a network entity in accordance with examples as disclosed herein. For example, the communications manager 1620 may be configured as or otherwise support a means for receiving, over a radio frequency bandwidth, a signal including a set of reference signals arranged across the radio frequency bandwidth in accordance with a comb pattern based on a baseband bandwidth supported by a UE. The communications manager 1620 may be configured as or otherwise support a means for obtaining channel measurements for the radio frequency bandwidth using the set of reference signals.

Additionally, or alternatively, the communications manager 1620 may support wireless communications at a network entity in accordance with examples as disclosed herein. For example, the communications manager 1620 may be configured as or otherwise support a means for generating, over a radio frequency bandwidth, a signal including a set of reference signals arranged in accordance with a comb pattern based on a baseband bandwidth capability of a UE. The communications manager 1620 may be configured as or otherwise support a means for transmitting, over the radio frequency bandwidth, the signal including the set of reference signals arranged across the radio frequency bandwidth in accordance with the comb pattern.

By including or configuring the communications manager 1620 in accordance with examples as described herein, the device 1605 may support techniques for improved communication reliability, reduced latency, reduced power consumption, more efficient utilization of communication resources, improved coordination between devices, longer battery life, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the processor 1635, the memory 1625, the code 1630, the transceiver 1610, or any combination thereof. For example, the code 1630 may include instructions executable by the processor 1635 to cause the device 1605 to perform various aspects of channel sounding techniques for reduced baseband bandwidth devices as described herein, or the processor 1635 and the memory 1625 may be otherwise configured to perform or support such operations.

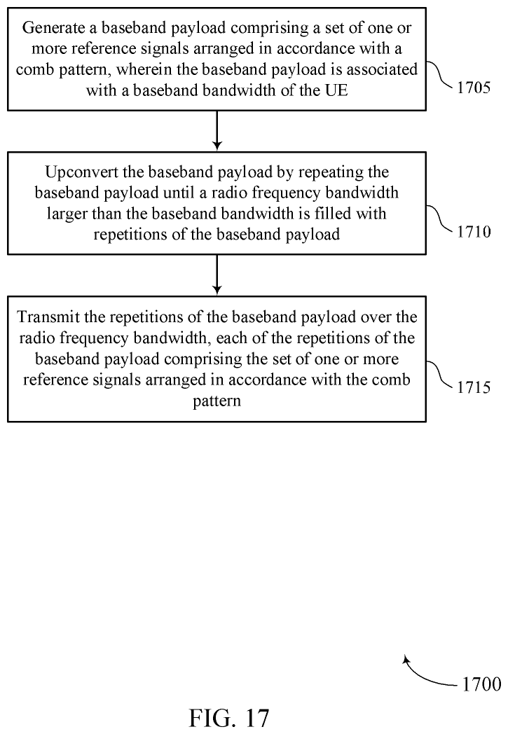

FIG. 17 shows a flowchart illustrating a method 1700 that supports channel sounding techniques for reduced baseband bandwidth devices in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include generating a baseband payload including a set of one or more reference signals arranged in accordance with a comb pattern, where the baseband payload is associated with a baseband bandwidth of the UE. The operations of 1705 may be performed in accordance with examples as disclosed herein. In some examples, aspects of the operations of 1705 may be performed by a baseband payload generation manager 1125 as described with reference to FIG. 11.

At 1710, the method may include upconverting the baseband payload by repeating the baseband payload until a radio frequency bandwidth larger than the baseband bandwidth is filled with repetitions of the baseband payload. The operations of 1710 may be performed in accordance with examples as disclosed herein. In some examples, aspects of the operations of 1710 may be performed by an upconversion manager 1130 as described with reference to FIG. 11.

At 1715, the method may include transmitting the repetitions of the baseband payload over the radio frequency bandwidth, each of the repetitions of the baseband payload including the set of one or more reference signals arranged in accordance with the comb pattern. The operations of 1715 may be performed in accordance with examples as disclosed herein. In some examples, aspects of the operations of 1715 may be performed by a payload transmission manager 1135 as described with reference to FIG. 11.

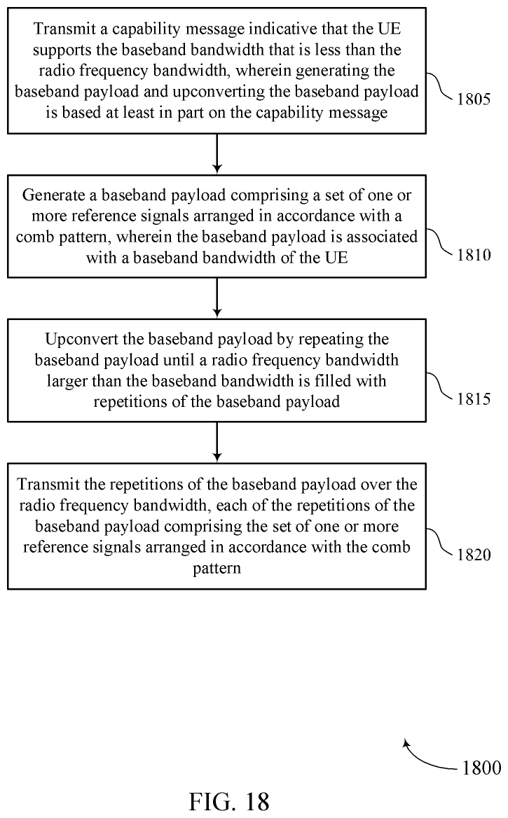

FIG. 18 shows a flowchart illustrating a method 1800 that supports channel sounding techniques for reduced baseband bandwidth devices in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1805, the method may include transmitting a capability message indicative that the UE supports the baseband bandwidth that is less than the radio frequency bandwidth, where generating the baseband payload and upconverting the baseband payload is based on the capability message. The operations of 1805 may be performed in accordance with examples as disclosed herein. In some examples, aspects of the operations of 1805 may be performed by a capability indication manager 1155 as described with reference to FIG. 11.

At 1810, the method may include generating a baseband payload including a set of one or more reference signals arranged in accordance with a comb pattern, where the baseband payload is associated with a baseband bandwidth of the UE. The operations of 1810 may be performed in accordance with examples as disclosed herein. In some examples, aspects of the operations of 1810 may be performed by a baseband payload generation manager 1125 as described with reference to FIG. 11.

At 1815, the method may include upconverting the baseband payload by repeating the baseband payload until a radio frequency bandwidth larger than the baseband bandwidth is filled with repetitions of the baseband payload. The operations of 1815 may be performed in accordance with examples as disclosed herein. In some examples, aspects of the operations of 1815 may be performed by an upconversion manager 1130 as described with reference to FIG. 11.

At 1820, the method may include transmitting the repetitions of the baseband payload over the radio frequency bandwidth, each of the repetitions of the baseband payload including the set of one or more reference signals arranged in accordance with the comb pattern. The operations of 1820 may be performed in accordance with examples as disclosed herein. In some examples, aspects of the operations of 1820 may be performed by a payload transmission manager 1135 as described with reference to FIG. 11.

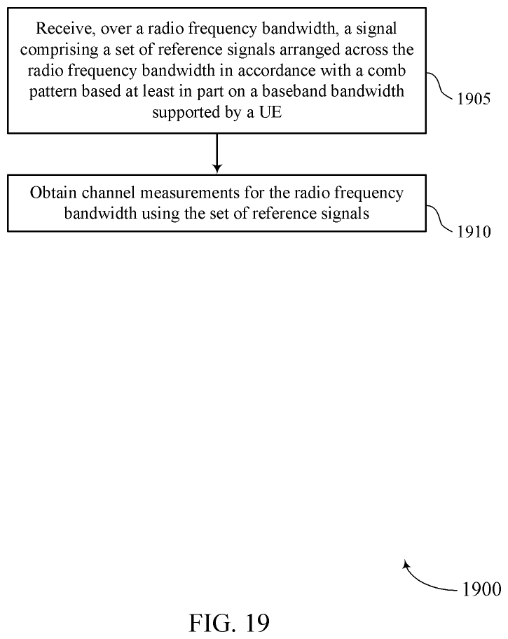

FIG. 19 shows a flowchart illustrating a method 1900 that supports channel sounding techniques for reduced baseband bandwidth devices in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1905, the method may include receiving, over a radio frequency bandwidth, a signal including a set of reference signals arranged across the radio frequency bandwidth in accordance with a comb pattern based on a baseband bandwidth supported by a UE. The operations of 1905 may be performed in accordance with examples as disclosed herein. In some examples, aspects of the operations of 1905 may be performed by a signal reception component 1525 as described with reference to FIG. 15.

At 1910, the method may include obtaining channel measurements for the radio frequency bandwidth using the set of reference signals. The operations of 1910 may be performed in accordance with examples as disclosed herein. In some examples, aspects of the operations of 1910 may be performed by a channel measurement component 1530 as described with reference to FIG. 15.

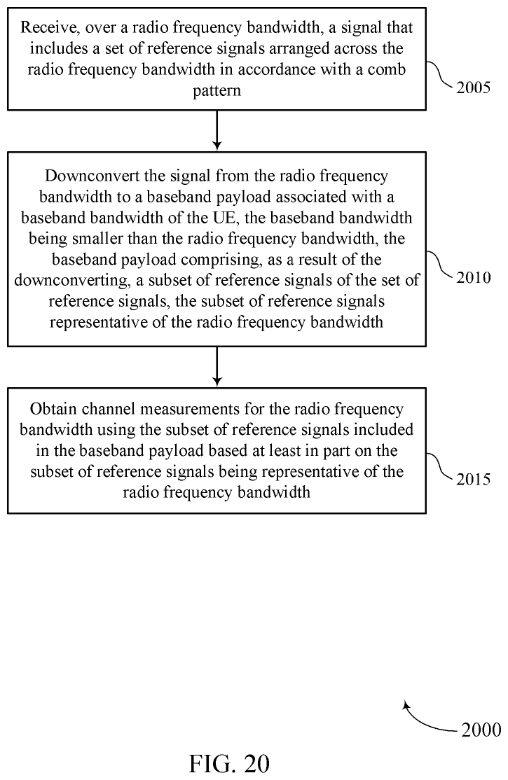

FIG. 20 shows a flowchart illustrating a method 2000 that supports channel sounding techniques for reduced baseband bandwidth devices in accordance with one or more aspects of the present disclosure. The operations of the method 2000 may be implemented by a UE or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include receiving, over a radio frequency bandwidth, a signal that includes a set of reference signals arranged across the radio frequency bandwidth in accordance with a comb pattern. The operations of 2005 may be performed in accordance with examples as disclosed herein. In some examples, aspects of the operations of 2005 may be performed by a signal reception manager 1140 as described with reference to FIG. 11.

At 2010, the method may include downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth. The operations of 2010 may be performed in accordance with examples as disclosed herein. In some examples, aspects of the operations of 2010 may be performed by a downconversion manager 1145 as described with reference to FIG. 11.

At 2015, the method may include obtaining channel measurements for the radio frequency bandwidth using the subset of reference signals included in the baseband payload based on the subset of reference signals being representative of the radio frequency bandwidth. The operations of 2015 may be performed in accordance with examples as disclosed herein. In some examples, aspects of the operations of 2015 may be performed by a channel measurement manager 1150 as described with reference to FIG. 11.

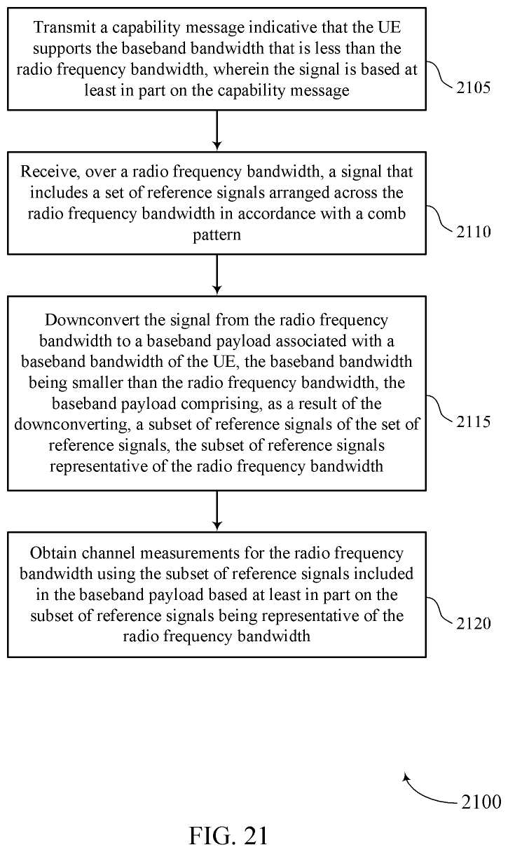

FIG. 21 shows a flowchart illustrating a method 2100 that supports channel sounding techniques for reduced baseband bandwidth devices in accordance with one or more aspects of the present disclosure. The operations of the method 2100 may be implemented by a UE or its components as described herein. For example, the operations of the method 2100 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2105, the method may include transmitting a capability message indicative that the UE supports the baseband bandwidth that is less than the radio frequency bandwidth, where the signal is based on the capability message. The operations of 2105 may be performed in accordance with examples as disclosed herein. In some examples, aspects of the operations of 2105 may be performed by a capability indication manager 1155 as described with reference to FIG. 11.

At 2110, the method may include receiving, over a radio frequency bandwidth, a signal that includes a set of reference signals arranged across the radio frequency bandwidth in accordance with a comb pattern. The operations of 2110 may be performed in accordance with examples as disclosed herein. In some examples, aspects of the operations of 2110 may be performed by a signal reception manager 1140 as described with reference to FIG. 11.

At 2115, the method may include downconverting the signal from the radio frequency bandwidth to a baseband payload associated with a baseband bandwidth of the UE, the baseband bandwidth being smaller than the radio frequency bandwidth, the baseband payload including, as a result of the downconverting, a subset of reference signals of the set of reference signals, the subset of reference signals representative of the radio frequency bandwidth. The operations of 2115 may be performed in accordance with examples as disclosed herein. In some examples, aspects of the operations of 2115 may be performed by a downconversion manager 1145 as described with reference to FIG. 11.

At 2120, the method may include obtaining channel measurements for the radio frequency bandwidth using the subset of reference signals included in the baseband payload based on the subset of reference signals being representative of the radio frequency bandwidth. The operations of 2120 may be performed in accordance with examples as disclosed herein. In some examples, aspects of the operations of 2120 may be performed by a channel measurement manager 1150 as described with reference to FIG. 11.

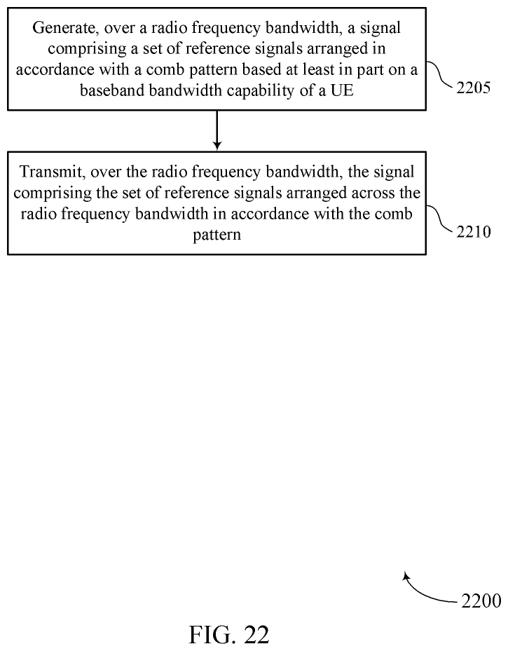

FIG. 22 shows a flowchart illustrating a method 2200 that supports channel sounding techniques for reduced baseband bandwidth devices in accordance with one or more aspects of the present disclosure. The operations of the method 2200 may be implemented by a network entity or its components as described herein. For example, the operations of the method 2200 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2205, the method may include generating, over a radio frequency bandwidth, a signal including a set of reference signals arranged in accordance with a comb pattern based on a baseband bandwidth capability of a UE. The operations of 2205 may be performed in accordance with examples as disclosed herein. In some examples, aspects of the operations of 2205 may be performed by a signal generation component 1535 as described with reference to FIG. 15.

At 2210, the method may include transmitting, over the radio frequency bandwidth, the signal including the set of reference signals arranged across the radio frequency bandwidth in accordance with the comb pattern. The operations of 2210 may be performed in accordance with examples as disclosed herein. In some examples, aspects of the operations of 2210 may be performed by a signal transmission component 1540 as described with reference to FIG. 15.

The following provides an overview of aspects of the present disclosure:
Aspect 1: A method for wireless communications at a UE, comprising: generating a baseband payload comprising a set of one or more reference signals arranged in accordance with a comb pattern, wherein the baseband payload is associated with a baseband bandwidth of the UE; upconverting the baseband payload by repeating the baseband payload until a radio frequency bandwidth larger than the baseband bandwidth is filled with repetitions of the baseband payload; and transmitting the repetitions of the baseband payload over the radio frequency bandwidth, each of the repetitions of the baseband payload comprising the set of one or more reference signals arranged in accordance with the comb pattern.
Aspect 2: The method of aspect 1, further comprising: transmitting a capability message indicative that the UE supports the baseband bandwidth that is less than the radio frequency bandwidth, wherein generating the baseband payload and upconverting the baseband payload is based at least in part on the capability message.
Aspect 3: The method of any of aspects 1 through 2, further comprising: transmitting a capability message indicative that the UE is capable of upconverting the baseband payload by repeating the baseband payload until the radio frequency bandwidth is filled with repetitions of the baseband payload.
Aspect 4: The method of any of aspects 1 through 3, further comprising: receiving a message comprising an indication of the comb pattern for the UE to apply to the set of one or more reference signals.
Aspect 5: The method of any of aspects 1 through 4, further comprising: receiving a message indicating for the UE to generate the baseband payload and upconvert the baseband payload by repeating the baseband payload until the radio frequency bandwidth is filled with the repetitions of the baseband payload.
Aspect 6: The method of any of aspects 1 through 5, wherein generating the baseband payload further comprises: arranging the set of one or more reference signals in accordance with the comb pattern based at least in part on a number of repetitions of the baseband payload to fill the radio frequency bandwidth, wherein a comb value associated with the comb pattern is greater than or equal to the number of repetitions.
Aspect 7: The method of any of aspects 1 through 6, further comprising: switching, during a transmission gap prior to a reference signal of the set of one or more reference signals, from transmitting over a narrowband bandwidth equal to the baseband bandwidth to transmitting over the radio frequency bandwidth to transmit the reference signal from the set of one or more reference signals.
Aspect 8: The method of any of aspects 1 through 7, further comprising: switching, during a transmission gap after a reference signal of the set of one or more reference signals, from transmitting over the radio frequency bandwidth to transmitting over a narrowband bandwidth equal to the baseband bandwidth to transmit signals other than the set of one or more reference signals.
Aspect 9: The method of any of aspects 1 through 8, wherein a transmission gap for switching between transmitting over a narrowband bandwidth equal to the baseband bandwidth or the radio frequency bandwidth is based at least in part on whether a center frequency of the baseband bandwidth is equivalent to a center frequency of the radio frequency bandwidth.
Aspect 10: The method of any of aspects 1 through 9, wherein a center frequency of a narrowband bandwidth equal to the baseband bandwidth is equivalent to a center frequency of the radio frequency bandwidth.
Aspect 11: The method of any of aspects 1 through 10, wherein a center frequency of a narrowband bandwidth equal to the baseband bandwidth is different from a center frequency of the radio frequency bandwidth.
Aspect 12: A method for wireless communications at a network entity, comprising: receiving, over a radio frequency bandwidth, a signal comprising a set of reference signals arranged across the radio frequency bandwidth in accordance with a comb pattern based at least in part on a baseband bandwidth supported by a UE; and obtaining channel measurements for the radio frequency bandwidth using the set of reference signals.
Aspect 13: The method of aspect 12, further comprising: receiving a capability message indicative that the UE supports the baseband bandwidth that is less than the radio frequency bandwidth, wherein receiving the signal is based at least in part on the capability message.
Aspect 14: The method of any of aspects 12 through 13, further comprising: receiving a capability message indicative that the UE is capable of upconverting a baseband payload by repeating the baseband payload until the radio frequency bandwidth is filled with repetitions of the baseband payload.
Aspect 15: The method of any of aspects 12 through 14, further comprising: transmitting a message comprising an indication of the comb pattern for the UE to apply to the signal.
Aspect 16: The method of any of aspects 12 through 15, further comprising: transmitting a message indicating for the UE to generate a baseband payload and upconvert the baseband payload by repeating the baseband payload until the radio frequency bandwidth is filled with repetitions of the baseband payload.
Aspect 17: The method of any of aspects 12 through 16, wherein the set of reference signals are arranged in accordance with the comb pattern based at least in part on a number of repetitions of a baseband payload of the UE to fill the radio frequency bandwidth, a comb value associated with the comb pattern is greater than or equal to the number of repetitions.
Aspect 18: The method of any of aspects 12 through 17, wherein a number of subcarriers between each reference signal of the set of reference signals are unoccupied based at least in part on an integer multiple of the baseband bandwidth of the UE to the radio frequency bandwidth, the number of subcarriers left unoccupied is equal to the integer multiple minus one.
Aspect 19: A method for wireless communications at a UE, comprising: receiving, over a radio frequency bandwidth, a signal that includes a set of reference signals arranged across the radio frequency bandwidth in accordance with a comb pattern; downconverting the signal from the radio frequency bandwidth to a baseband payload associated with a baseband bandwidth of the UE, the baseband bandwidth being smaller than the radio frequency bandwidth, the baseband payload comprising, as a result of the downconverting, a subset of reference signals of the set of reference signals, the subset of reference signals representative of the radio frequency bandwidth; and obtaining channel measurements for the radio frequency bandwidth using the subset of reference signals included in the baseband payload based at least in part on the subset of reference signals being representative of the radio frequency bandwidth.
Aspect 20: The method of aspect 19, further comprising: transmitting a capability message indicative that the UE supports the baseband bandwidth that is less than the radio frequency bandwidth, wherein the signal is based at least in part on the capability message.
Aspect 21: The method of any of aspects 19 through 20, further comprising: transmitting a capability message indicative that the UE is capable of downconverting the signal from the radio frequency bandwidth to the baseband payload associated with the baseband bandwidth of the UE, wherein receiving the signal is based at least in part on the capability message.
Aspect 22: The method of any of aspects 19 through 21, further comprising: receiving a message indicating for the UE to downconvert the signal from the radio frequency bandwidth to the baseband payload associated with the baseband bandwidth of the UE.
Aspect 23: The method of any of aspects 19 through 22, wherein downconverting the signal further comprises: aligning a number of analog carriers of the signal in a staggered configuration resulting in the baseband payload comprising the subset of reference signals representative of the radio frequency bandwidth, wherein the number of analog carriers is equal to the radio frequency bandwidth divided by the baseband bandwidth.
Aspect 24: The method of any of aspects 19 through 23, further comprising: receiving a second signal over a narrowband bandwidth; and applying a wideband filter to the signal received over the radio frequency bandwidth, the second signal received over the narrowband bandwidth, or both regardless of the respective bandwidths of the signal and the second signal.
Aspect 25: The method of any of aspects 19 through 24, further comprising: receiving a second signal over a narrowband bandwidth; and applying a wideband filter to the signal received over the radio frequency bandwidth and a narrowband filter to the second signal received over the narrowband bandwidth based at least in part on the respective bandwidths of the signal and the second signal.
Aspect 26: The method of any of aspects 19 through 25, further comprising: switching, during a measurement gap prior to a reference signal of the set of reference signals, from monitoring a narrowband bandwidth equal to the baseband bandwidth to monitoring the radio frequency bandwidth to receive the reference signal.
Aspect 27: The method of any of aspects 19 through 26, further comprising: switching, during a measurement gap after a reference signal of the set of reference signals, from monitoring the radio frequency bandwidth to monitoring a narrowband bandwidth equal to the baseband bandwidth to receive signals other than the set of reference signals.
Aspect 28: The method of any of aspects 19 through 27, wherein a measurement gap for switching between monitoring the baseband bandwidth or the radio frequency bandwidth is based at least in part on whether a center frequency of a narrowband bandwidth equal to the baseband bandwidth is equivalent to a center frequency of the radio frequency bandwidth.
Aspect 29: The method of any of aspects 19 through 28, wherein a center frequency of a narrowband bandwidth equal to the baseband bandwidth is equivalent to a center frequency of the radio frequency bandwidth.
Aspect 30: The method of any of aspects 19 through 29, wherein a center frequency of a narrowband bandwidth equal to the baseband bandwidth is different from a center frequency of the radio frequency bandwidth.
Aspect 31: The method of any of aspects 19 through 30, wherein the set of reference signals are arranged in accordance with the comb pattern based at least in part on a result of dividing the radio frequency bandwidth by the baseband bandwidth, a comb value associated with the comb pattern is greater than or equal to the result.
Aspect 32: The method of any of aspects 19 through 31, wherein a number of subcarriers between each reference signal of the set of reference signals are unoccupied based at least in part on an integer multiple of the baseband bandwidth to the radio frequency bandwidth, the number of subcarriers left unoccupied is equal to the integer multiple minus one.
Aspect 33: The method of aspect 32, wherein the unoccupied subcarriers are adjacent to one another, or are arranged in accordance with a frequency interval based at least in part on a rate matching pattern.
Aspect 34: A method for wireless communications at a network entity, comprising: generating, over a radio frequency bandwidth, a signal comprising a set of reference signals arranged in accordance with a comb pattern based at least in part on a baseband bandwidth capability of a UE; and transmitting, over the radio frequency bandwidth, the signal comprising the set of reference signals arranged across the radio frequency bandwidth in accordance with the comb pattern.
Aspect 35: The method of aspect 34, further comprising: receiving a capability message indicative that the UE supports a baseband bandwidth that is less than the radio frequency bandwidth, wherein generating the signal is based at least in part on the capability message.
Aspect 36: The method of any of aspects 34 through 35, further comprising: receiving a capability message indicative that the UE is capable of downconverting the signal from the radio frequency bandwidth to a baseband payload associated with a baseband bandwidth of the UE, wherein generating the signal is based at least in part on the capability message.
Aspect 37: The method of any of aspects 34 through 36, further comprising: transmitting a message indicating for the UE to downconvert the signal from the radio frequency bandwidth to a baseband payload associated with a baseband bandwidth of the UE.
Aspect 38: The method of any of aspects 34 through 37, wherein generating the signal further comprises: arranging a measurement gap before and after each reference signal of the set of reference signals, wherein the measurement gap is based at least in part on whether a center frequency of a narrowband bandwidth equal to a baseband bandwidth of the UE is equivalent to a center frequency of the radio frequency bandwidth.
Aspect 39: The method of any of aspects 34 through 38, wherein generating the signal further comprises: arranging the set of reference signals in accordance with the comb pattern based at least in part on a number of repetitions of a baseband payload of the UE to fill the radio frequency bandwidth, wherein a comb value associated with the comb pattern is greater than or equal to the number of repetitions.
Aspect 40: The method of any of aspects 34 through 39, wherein generating the signal further comprises: refraining from occupying a number of subcarriers between each reference signal of the set of reference signals based at least in part on an integer multiple of a baseband bandwidth of the UE to the radio frequency bandwidth, wherein the number of subcarriers left unoccupied is equal to the integer multiple minus one.
Aspect 41: The method of aspect 40, wherein the unoccupied subcarriers are

adjacent to one another, or are arranged in accordance with a frequency interval based at least in part on a rate matching pattern.
Aspect 42: An apparatus for wireless communications, comprising a processor; memory coupled with the processor; and instructions stored in the memory and executable by the processor to cause the apparatus to perform a method of any of aspects 1 through 11.
Aspect 43: An apparatus for wireless communications, comprising at least one means for performing a method of any of aspects 1 through 11.
Aspect 44: A non-transitory computer-readable medium storing code for wireless communications, the code comprising instructions executable by a processor to perform a method of any of aspects 1 through 11.
Aspect 45: An apparatus for wireless communications, comprising a processor; memory coupled with the processor; and instructions stored in the memory and executable by the processor to cause the apparatus to perform a method of any of aspects 12 through 18.
Aspect 46: An apparatus for wireless communications, comprising at least one means for performing a method of any of aspects 12 through 18.
Aspect 47: A non-transitory computer-readable medium storing code for wireless communications, the code comprising instructions executable by a processor to perform a method of any of aspects 12 through 18.
Aspect 48: An apparatus for wireless communications, comprising a processor; memory coupled with the processor; and instructions stored in the memory and executable by the processor to cause the apparatus to perform a method of any of aspects 19 through 33.
Aspect 49: An apparatus for wireless communications, comprising at least one means for performing a method of any of aspects 19 through 33.
Aspect 50: A non-transitory computer-readable medium storing code for wireless communications, the code comprising instructions executable by a processor to perform a method of any of aspects 19 through 33.
Aspect 51: An apparatus for wireless communications, comprising a processor; memory coupled with the processor; and instructions stored in the memory and executable by the processor to cause the apparatus to perform a method of any of aspects 34 through 41.
Aspect 52: An apparatus for wireless communications, comprising at least one means for performing a method of any of aspects 34 through 41.
Aspect 53: A non-transitory computer-readable medium storing code for wireless communications, the code comprising instructions executable by a processor to perform a method of any of aspects 34 through 41.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
generating a baseband payload comprising a set of one or more reference signals arranged in accordance with a comb pattern, wherein the baseband payload is associated with a baseband bandwidth of the UE;
upconverting the baseband payload by repeating the baseband payload until a radio frequency bandwidth larger than the baseband bandwidth is filled with repetitions of the baseband payload; and
transmitting the repetitions of the baseband payload over the radio frequency bandwidth, each of the repetitions of the baseband payload comprising the set of one or more reference signals arranged in accordance with the comb pattern.

2. The method of claim 1, further comprising:
transmitting a capability message indicative that the UE supports the baseband bandwidth that is less than the radio frequency bandwidth, wherein generating the baseband payload and upconverting the baseband payload is based at least in part on the capability message.

3. The method of claim 1, further comprising:
transmitting a capability message indicative that the UE is capable of upconverting the baseband payload by repeating the baseband payload until the radio frequency bandwidth is filled with repetitions of the baseband payload.

4. The method of claim 1, further comprising:
receiving a message comprising an indication of the comb pattern for the UE to apply to the set of one or more reference signals.

5. The method of claim 1, further comprising:
receiving a message indicating for the UE to generate the baseband payload and upconvert the baseband payload by repeating the baseband payload until the radio frequency bandwidth is filled with the repetitions of the baseband payload.

6. The method of claim 1, wherein generating the baseband payload further comprises:
arranging the set of one or more reference signals in accordance with the comb pattern based at least in part on a number of repetitions of the baseband payload to fill the radio frequency bandwidth, wherein a comb value associated with the comb pattern is greater than or equal to the number of repetitions.

7. The method of claim 1, further comprising:
switching, during a transmission gap prior to a reference signal of the set of one or more reference signals, from transmitting over a narrowband bandwidth equal to the baseband bandwidth to transmitting over the radio frequency bandwidth to transmit the reference signal from the set of one or more reference signals.

8. The method of claim 1, further comprising:
switching, during a transmission gap after a reference signal of the set of one or more reference signals, from transmitting over the radio frequency bandwidth to transmitting over a narrowband bandwidth equal to the baseband bandwidth to transmit signals other than the set of one or more reference signals.

9. The method of claim 1, wherein a transmission gap for switching between transmitting over a narrowband bandwidth equal to the baseband bandwidth or the radio frequency bandwidth is based at least in part on whether a center frequency of the baseband bandwidth is equivalent to a center frequency of the radio frequency bandwidth.

10. A method for wireless communications at a user equipment (UE), comprising:
receiving, over a radio frequency bandwidth, a signal that includes a set of reference signals arranged across the radio frequency bandwidth in accordance with a comb pattern;
downconverting the signal from the radio frequency bandwidth to a baseband payload associated with a baseband bandwidth of the UE, the baseband bandwidth being smaller than the radio frequency bandwidth, the baseband payload comprising, as a result of the downconverting, a subset of reference signals of the set of reference signals, the subset of reference signals representative of the radio frequency bandwidth; and
obtaining channel measurements for the radio frequency bandwidth using the subset of reference signals included in the baseband payload based at least in part on the subset of reference signals being representative of the radio frequency bandwidth.

11. The method of claim 10, further comprising:
transmitting a capability message indicative that the UE supports the baseband bandwidth that is less than the radio frequency bandwidth, wherein the signal is based at least in part on the capability message.

12. The method of claim 10, further comprising:
transmitting a capability message indicative that the UE is capable of downconverting the signal from the radio frequency bandwidth to the baseband payload associated with the baseband bandwidth of the UE, wherein receiving the signal is based at least in part on the capability message.

13. The method of claim 10, further comprising:
receiving a message indicating for the UE to downconvert the signal from the radio frequency bandwidth to the baseband payload associated with the baseband bandwidth of the UE.

14. The method of claim 10, wherein downconverting the signal further comprises:
aligning a number of analog carriers of the signal in a staggered configuration resulting in the baseband payload comprising the subset of reference signals representative of the radio frequency bandwidth, wherein the number of analog carriers is equal to the radio frequency bandwidth divided by the baseband bandwidth.

15. The method of claim 10, further comprising:
receiving a second signal over a narrowband bandwidth; and
applying a wideband filter to the signal received over the radio frequency bandwidth, the second signal received over the narrowband bandwidth, or both regardless of the respective bandwidths of the signal and the second signal.

16. The method of claim 10, further comprising:
receiving a second signal over a narrowband bandwidth; and
applying a wideband filter to the signal received over the radio frequency bandwidth and a narrowband filter to the second signal received over the narrowband bandwidth based at least in part on the respective bandwidths of the signal and the second signal.

17. The method of claim 10, further comprising:
switching, during a measurement gap prior to a reference signal of the set of reference signals, from monitoring a narrowband bandwidth equal to the baseband bandwidth to monitoring the radio frequency bandwidth to receive the reference signal.

18. The method of claim 10, further comprising:
switching, during a measurement gap after a reference signal of the set of reference signals, from monitoring the radio frequency bandwidth to monitoring a narrowband bandwidth equal to the baseband bandwidth to receive signals other than the set of reference signals.

19. The method of claim 10, wherein a measurement gap for switching between monitoring the baseband bandwidth or the radio frequency bandwidth is based at least in part on whether a center frequency of a narrowband bandwidth equal to the baseband bandwidth is equivalent to a center frequency of the radio frequency bandwidth.

20. The method of claim 10, wherein the set of reference signals are arranged in accordance with the comb pattern based at least in part on a result of dividing the radio frequency bandwidth by the baseband bandwidth, a comb value associated with the comb pattern is greater than or equal to the result.

21. An apparatus for wireless communications, comprising:
a processor;
memory coupled with the processor; and
instructions stored in the memory and executable by the processor to cause the apparatus to:
generate a baseband payload comprising a set of one or more reference signals arranged in accordance with a comb pattern, wherein the baseband payload is associated with a baseband bandwidth of a user equipment (UE);
upconvert the baseband payload by repeating the baseband payload until a radio frequency bandwidth larger than the baseband bandwidth is filled with repetitions of the baseband payload; and
transmit the repetitions of the baseband payload over the radio frequency bandwidth, each of the repetitions of the baseband payload comprising the set of one or more reference signals arranged in accordance with the comb pattern.

22. The apparatus of claim 21, wherein the instructions are further executable by the processor to cause the apparatus to:
transmit a capability message indicative that the UE supports the baseband bandwidth that is less than the radio frequency bandwidth, wherein generating the baseband payload and upconverting the baseband payload is based at least in part on the capability message.

23. The apparatus of claim 21, wherein the instructions are further executable by the processor to cause the apparatus to:
transmit a capability message indicative that the UE is capable of upconverting the baseband payload by repeating the baseband payload until the radio frequency bandwidth is filled with repetitions of the baseband payload.

24. The apparatus of claim 21, wherein the instructions are further executable by the processor to cause the apparatus to:
receive a message comprising an indication of the comb pattern for the UE to apply to the set of one or more reference signals.

25. The apparatus of claim 21, wherein the instructions are further executable by the processor to cause the apparatus to:
receive a message indicating for the UE to generate the baseband payload and upconvert the baseband payload by repeating the baseband payload until the radio frequency bandwidth is filled with the repetitions of the baseband payload.

26. The apparatus of claim 21, wherein the instructions to generate the baseband payload are further executable by the processor to cause the apparatus to:
arrange the set of one or more reference signals in accordance with the comb pattern based at least in part on a number of repetitions of the baseband payload to fill the radio frequency bandwidth, wherein a comb value associated with the comb pattern is greater than or equal to the number of repetitions.

27. An apparatus for wireless communications, comprising:
a processor;
memory coupled with the processor; and
instructions stored in the memory and executable by the processor to cause the apparatus to:
receive, over a radio frequency bandwidth, a signal that includes a set of reference signals arranged across the radio frequency bandwidth in accordance with a comb pattern;
downconvert the signal from the radio frequency bandwidth to a baseband payload associated with a baseband bandwidth of a user equipment (UE), the baseband bandwidth being smaller than the radio frequency bandwidth, the baseband payload comprising, as a result of the downconverting, a subset of reference signals of the set of reference signals, the subset of reference signals representative of the radio frequency bandwidth; and
obtain channel measurements for the radio frequency bandwidth using the subset of reference signals included in the baseband payload based at least in part on the subset of reference signals being representative of the radio frequency bandwidth.

28. The apparatus of claim 27, wherein the instructions are further executable by the processor to cause the apparatus to:
transmit a capability message indicative that the UE supports the baseband bandwidth that is less than the radio frequency bandwidth, wherein the signal is based at least in part on the capability message.

29. The apparatus of claim 27, wherein the instructions are further executable by the processor to cause the apparatus to:
transmit a capability message indicative that the UE is capable of downconverting the signal from the radio frequency bandwidth to the baseband payload associated with the baseband bandwidth of the UE, wherein receiving the signal is based at least in part on the capability message.

30. The apparatus of claim 27, wherein the instructions are further executable by the processor to cause the apparatus to:
receive a message indicating for the UE to downconvert the signal from the radio frequency bandwidth to the baseband payload associated with the baseband bandwidth of the UE.
